(19) United States
(12) Patent Application Publication
(10) Pub. No.: US 2006/0259360 A1
(43) Pub. Date: Nov. 16, 2006

(54) Multiple Attribute and Behavior-based Advertising Process

(75) Inventors: Steven Dennis Flinn, Houston, TX (US); Naomi Felina Moneypenny, Houston, TX (US)

Correspondence Address: MANYWORLDS, INC., 510 BERING DRIVE, SUITE 470 (IP DEPARTMENT), HOUSTON, TX, 77057, US

(73) Assignee: ManyWorlds, Inc., Houston, TX (US)

(21) Appl. No.: 11/381,314

(22) Filed: May 2, 2006

Related U.S. Application Data
(60) Provisional application No. 60/682,122, filed on May 16, 2005.
(60) Provisional application No. 60/742,613, filed on Dec. 5, 2005.

(51) Int. Cl. G06Q 30/00

(52) U.S. Cl. 705/14

(57) ABSTRACT

A method and system for a multi-attribute and advertisement recipient behavior-based advertising process is disclosed. The advertisement recipient behavior-based advertising process enables advertising pricing schedules to apply to a great variety of advertising recipient behaviors beyond “pay per view or impression” and “pay per click”. The advertisement recipient behavior-based advertising process may be used in conjunction with a multi-attribute advertising pricing and delivery model, and can apply to advertising delivered in conjunction with search, sponsored recommendations, or any other on-line or digital advertising approach.

### CROSS-REFERENCE TO RELATED APPLICATIONS

The present application claims priority under 35 U.S.C. §119(e) to U.S. Provisional Patent Application Ser. No. 60/682,122, entitled “Multi-Attribute Advertising Process,” filed on May 16, 2005, and to U.S. Provisional Patent Application Ser. No. 60/742,613, entitled “Advertising Recipient Behavior-based Advertising Process,” filed on Dec. 5, 2005.

### FIELD OF THE INVENTION

This invention relates to the pricing, managing and delivering of computer-based advertising.

### BACKGROUND OF THE INVENTION

Advertising that is more targeted to the preferences, interests and/or intentions of the recipient of the advertising is much more valuable to the purchaser of said advertising, as well as to the recipient of the said advertising, than relatively less targeted advertising. For example, it is for that reason that advertisements associated with search terms on the Internet have become so successful—the searching of the term informs to some degree the expected intention of the person doing the searching. The said person is therefore more likely to welcome an ad and take action in accordance with the advertisement presented during the search than if such an ad was presented in a more general context.

However, a search term alone is still a relatively blunt instrument from which to infer preferences, interests, or intentions of the searcher. Therefore, an advertiser paying for an advertisement to display in association with a search term, or based on any other single ad recipient attribute, is still paying for delivery of advertising to a very high proportion of ad recipients who will not be interested in, or are unqualified for, procurement of the products or services being advertised. And, of course, ads that don not hit the mark for the recipient are likely to diminish the overall experience of the recipient's consumption or use of the medium in which the un-targeted advertising is being presented. The prior art includes advertising pricing processes that enable on-line advertisers to pay for a search term, and with options for restricting to the ad to recipients in a geographic region. Nevertheless, this is still a very coarse grained approach, yielding a high proportion of poorly targeted ads.

Further, in the prior art, the online advertising recipient is not provided with a basis for understanding why they received a specific ad. In some cases the delivery rationale may be obvious, but in other cases it may not be obvious, and in such cases where the ad recipient fails to understand in some level of detail why the recipient received the advertisement, the advertisement is less likely to be effective in inducing the desired ad recipient behavior sought by the advertiser. For example, not understanding the basis for delivery of the ad may limit the ability to make the ad recipient feel special, which has proved to be so important in many traditional in-person selling approaches. Further, opaqueness in ad delivery rationale may limit the ability of the advertisement to seem sufficiently authoritative, which has also proved important in traditional selling approaches.

Thus there is a need for an improved method and system of pricing and delivering advertising based on improved inferences of the advertising recipients' preferences and/or intentions, interests or intentions, and optionally combined with enabling advertising recipient convenient access to why the ad was delivered to them.

Alternatively, or in addition, current on-line advertising approaches such as Google's AdWords are often based on advertisers paying a fee per “click” of a displayed on-line advertisement by an on-line user. This fee approach has often proven to be advantageous to advertisers versus the predominant historical approach of paying per view or “impression,” as a click through of an on-line advertisement to a destination site is generally more indicative of the interest in, and intention to purchase, an advertised item than is simply being presented with an advertisement. Nevertheless, the vast majority of clicks do not lead directly to a purchase. Thus, the advertiser that pays for advertisements per click is still mostly paying for advertising recipient behaviors (i.e., clicking on the ad) that do not generate value to the advertiser. Further, pay per click is susceptible to “click fraud”, which can be difficult to rectify in all but its most blatant forms.

More advanced “pay for performance” on-line advertising approaches, besides the more standard pay per click are known in the prior art. For example, Snap.com utilizes a pay-per-purchase, or more broadly, a pay-per-action, approach. This method more aligns the value of the advertising to the advertiser to the cost of the advertisement. However, prior art pay-per-purchase or per-per-action may still fail in many cases to effectively link the receipt of advertising with recipient behaviors induced by the received advertising. For example, in the prior art it is not generally possible to link the consumption of the advertising to the purchase if the purchase is made during a different computer session. Further, such prior art approaches are ineffective in cases where the advertisement is delivered on-line, but the purchase is conducted off-line (for example, an ad for a restaurant is viewed by the ad recipient, who then travels to the restaurant and buys a meal).

In general, then, there is a need for improved advertising methods and systems in which delivery of the advertising is more aligned (or actively serves to generate more alignment) with preferences, interests, or intentions of advertising recipients, and optionally combined with improved methods for more generally aligning the value of generated with the advertising to the advertiser with the cost of the advertising.

### SUMMARY OF THE INVENTION

In accordance with the embodiments described herein, a method and system for a multi-attribute and advertising recipient behavior-based advertising process is disclosed.

The present invention provides a more complete and flexible approach to the pricing of advertising by generating advertising prices based, at least in part, on one or both of the following components: 1) a price factor associated with one or more inferred attributes associated with an advertising recipient, and 2) a price factor associated with one or more behaviors of an advertising recipient when presented with an advertisement. The present invention also provides for more effective advertising by enabling the delivery of advertising based on multiple attributes associated with the advertising recipient, the delivery of advertisement variations based on multiple attributes associated with the advertising recipient, and enabling delivery of explanatory information as to why an advertisement was delivered to an advertising recipient.

The present invention may apply the adaptive and/or recombinant methods and systems as described in PCT Patent Application No. PCT/US2004/37176, entitled “Adaptive Recombinant Systems,” filed on Nov. 4, 2004, and may apply the adaptive and/or recombinant processes, methods, and/or systems as described in PCT Patent Application No. PCT/US2005/011951, entitled “Adaptive Recombinant Processes”, filed on Apr. 8, 2005.

Other features and embodiments will become apparent from the following description, from the drawings, and from the claims.

### BRIEF DESCRIPTION OF THE DRAWINGS

FIG. 1 is a block diagram of a multi-attribute and/or multi-behavior-based advertising pricing process, according to some embodiments;

FIG. 2 is a flow diagram of the multi-attribute advertising pricing process, according to some embodiments;

FIG. 3 is a diagram of attribute vectors and associated attribute instances of the multi-attribute advertising pricing process, according to some embodiments;

FIG. 4 is a flow diagram of an advertising recipient behavior-based advertising pricing process, according to some embodiments;

FIG. 5 is a diagram of a recipient behavior vector and corresponding fee instances an advertising recipient behavior-based advertising pricing process, according to some embodiments;

FIG. 6A is a flow diagram of a multi-attribute advertising delivery process, according to some embodiments;

FIG. 6B is a flow diagram of a delivery rationale transparent multi-attribute advertising delivery process, according to some embodiments;

FIG. 7 is a flow diagram of advertising recipient behavior-based advertising processing, according to some embodiments;

FIG. 8A is a block diagram of a multi-attribute advertising process, according to some embodiments;

FIG. 8B is a block diagram of a transparent advertisement delivery rationale multi-attribute advertising process, according to some embodiments;

FIG. 9 is a diagram of a usage behavior framework, according to some embodiments;

FIG. 10 is a diagram of a user communities and associated relationships, according to some embodiments;

FIG. 11 is a block diagram of a the usage behavior information and inferences function, according to some embodiments;

FIG. 12 is a block diagram of an attribute vector instance/behavior inference mapping function, according to some embodiments;

FIG. 13 is a block diagram of a multi-attribute advertising process, according to some embodiments;

FIG. 14 is a block diagram of a multi-attribute and advertising recipient behavior-based advertising process, according to some embodiments; and

FIG. 15 is a diagram of alternative computing topologies of the multi-attribute and/or multi-behavior-based advertising processes, according to some embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In accordance with the embodiments described herein, a method and a system for development, management and application of multi-attribute and recipient behavior-based advertising pricing processes is disclosed.

The term “advertising” or “advertisement” or “ad” as defined herein, includes any means or approach of supplying information to one or more people for the purposes of directly or indirectly promoting commercial or non-commercial interests. This definition includes advertising, promotion, public relations, and increasing “mind share”.

In some embodiments, an advertisement may constitute an adaptive recommendation or sponsored recommendation as described in PCT Patent Application No. PCT/US2004/37176, entitled “Adaptive Recombinant Systems,” filed on Nov. 4, 2004, or as described in PCT Patent Application No. PCT/US2005/011951, entitled “Adaptive Recombinant Processes”, filed on Apr. 8, 2005, which are both hereby incorporated by reference as if set forth in their entirety.

The present invention provides a more complete and flexible approach to the pricing of on-line advertising by generating advertising prices based, at least in part, on one or both of the following components: 1) a price factor associated with one or more inferred characteristics or attributes associated with an advertising recipient, and 2) a price factor associated with the behavior of an advertising recipient when presented with an advertisement.

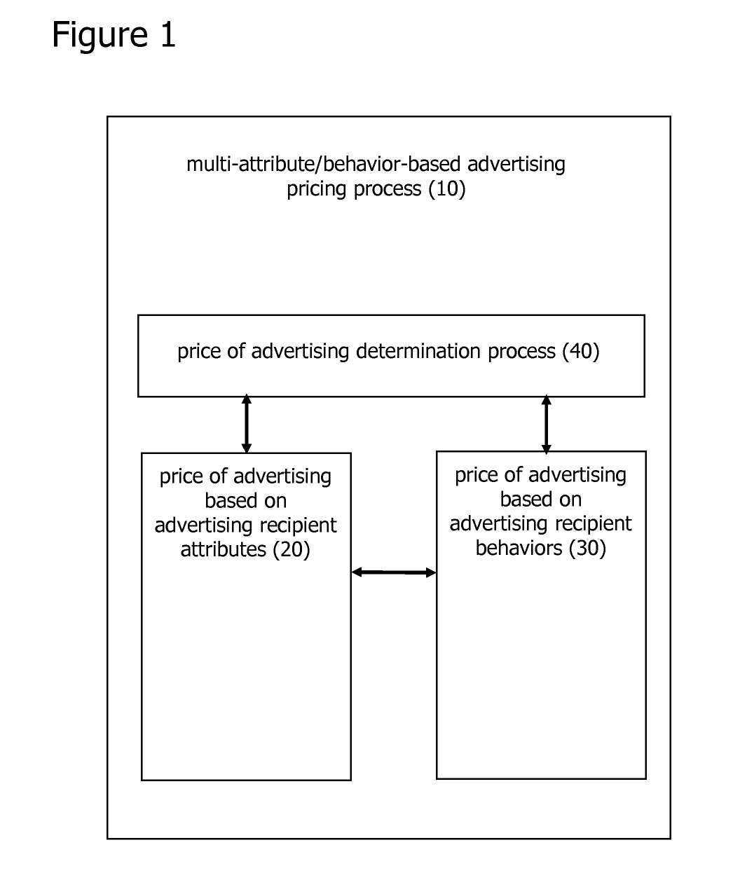

In accordance with some embodiments, FIG. 1 illustrates a multi-attribute and/or behavior-based advertising pricing process (10). A pricing method and system associated with delivery of an advertisement based on multiple advertisement recipient attributes 20 is shown. In addition, a pricing method and system associated with pricing of advertisements based on behaviors exhibited by a user when presented with an advertisement 30 is shown in FIG. 1. These two pricing methods and systems may be applied in the present invention separately, or in combination, in determining an advertising price schedule. Also shown is a price of advertisement determination process, method and system 40. The advertising price determination function 40 may apply to either the multi-attribute pricing method 20, or the ad recipient behavior based method 30, or to both methods. The ad price determination process 40 may generate an a priori determined fixed price for either method, or it may utilize a bidding or auction process to determine advertising prices for either method.

Prior art approaches to the pricing of advertising in a variety of media environments typically consist of pricing according to no more than one attribute that may roughly reflect inferred preferences and/or intentions, interests, or intentions of the intended recipients of the advertising. For example, in print media advertising pricing processes, the pricing of advertising is generally priced per issue, and may vary by the size of the ad, and perhaps the position of ad in the publication; such variations being generally independent of inferred ad recipient attributes.

For on-line media, advertisements have typically been sold by charging advertisers a fee per number of page views or impressions. More sophisticated prior art approaches includes advertising pricing processes that enable on-line advertisers to pay for their ad being displayed in conjunction with the results generated from a search term (e.g., Google's AdWords), and perhaps with a variable associated with the geographic region desired by the purchaser of the advertising. The success of search term-based advertising is underpinned by the fact that a search by a user reflects some level of intentionality by the user, and therefore an ad can be more targeted to the user than a general on-line banner ad, or the ads of broadcast media such as print publications, radio, television, etc.

However, a search term alone is still a relatively weak indicator of preferences and/or intentions of the subject user, or as an indicator of whether the searcher is even a potentially qualified buyer of the products or services being advertised.

The present invention improves on the prior art advertising pricing processes by enabling multiple attributes that may serve as proxies for the preferences and/or intentions, interests, intentions, and/or qualifications of intended advertising recipients, which can be applied to the process of the pricing and delivery of ads.

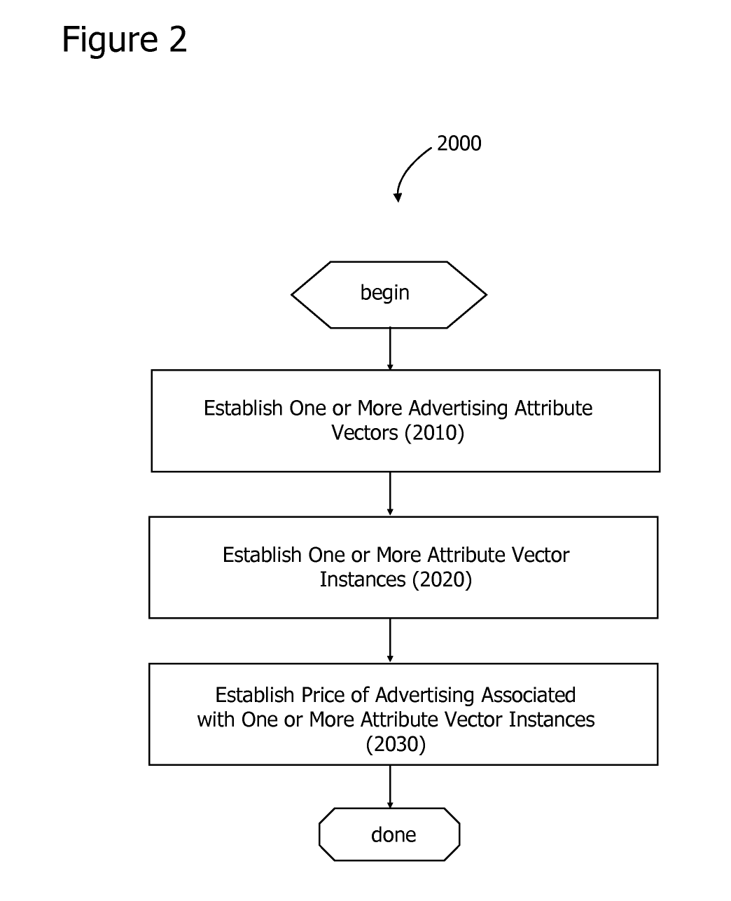

FIG. 2 is a flow chart of the multi-attribute pricing process 2000 of the present invention that may be used in conjunction with the multi attribute and/or advertising recipient behavior process 10 of FIG. 1. The process 2000 begins by establishing 2010 one or more advertising attribute vectors. An attribute vector includes a plurality of attributes, and it should be understood that the term “attribute vector” as used herein encompasses any collection of a plurality of attributes. An example attribute is “search term”. Other example attributes are “location”, “gender”, and “price sensitivity”. An attribute may have one or more possible values. For example, a value of the “search term” attribute may be “italian restaurant”—that is, “italian restaurant” is the term that a search engine user specifies. An example value of attribute “location” (meaning the current location of the user) could be “Houston, Tex.”, or “within 10 miles of 510 Bering Drive, Houston, Tex.”. The attribute values of “gender” may be “male” or “female”. The attribute values of “price sensitivity” may include “low cost”, “medium”, “insensitive”, and “prefers premium”.

It should be understood that the example attribute values given above are just specific examples, and that any symbolic or numeric expression may be used to create distinct values for a corresponding attribute.

An attribute value may be explicitly determined by a prospective advertising recipient, such as through entering a search term, but in other cases the attribute value may be derived from other information, which may include inferences associated with user interactions with computer-based systems, and/or through monitoring of behaviors by computer-based systems.

In general, an advertising attribute vector, with n attributes, can be described as follows:
Attribute Vector=(A₁, A₂, . . . Aₙ) (1)

In general, the corresponding attribute vector instance of expression (1) in which each attribute, Aₓ, takes a corresponding value, Vₓ, can be described as follows:
Attribute Vector Instance=(AV₁, AV₂, . . . AVₙ)
During process step 2010 of process 2000, one or more attribute vectors are established. The one or more attribute vectors established in step 2010 are used as input to process step 2020 of process 2000. In process step 2020, for each of the one or more attribute vectors, one or more corresponding attribute vector instances are established.

During process step 2030 of process 2000, a price is established for the one or more attribute vector instances. The price may be conditional on other parameters in addition to those within the attribute vector instance itself, e.g., the duration of time over which the advertisement is to be delivered. Or, all such parameters may be explicitly embedded into an attribute vector.

The price may be set in any manner, including though a pricing process where the price is set by the deliverer of the advertising, or through a pricing process in which prices for attribute vector instances are set through a bidding process by prospective advertisers.

So, in the example used above, associated with an attribute vector:
Attribute Vector=(Search Term, Location, Price Sensitivity) (3)

A prospective advertiser might pay for one or more attribute vector instances associated with the attribute vector of expression (3) as illustrated by the following example:
Attribute Vector Instance =(“Italian Restaurant, “Within 20 Miles of 510 Bering Street, Houston, Tex.”, “Insensitive” or “Prefers Premium”) (3)

It should be understood that multiple attribute vector instances may be specified through application of logical operators such as “or” (as in the example above—“Insensitive” or “Prefers Premium”), “and”, and mathematical magnitude delimiters such as “<” or “>”.

In some embodiments, an attribute vector instance may be sold exclusively to one advertiser. In other embodiments, more than one advertiser may be able to purchase a particular attribute vector instance. In that case, purchase prices may depend on specifics related to delivery prioritization. For example, a higher price paid for an attribute vector instance may enable the corresponding advertisement to be more prominently displayed or otherwise delivered to ad recipients than the ads of other advertisers who have paid less for the attribute vector instance.

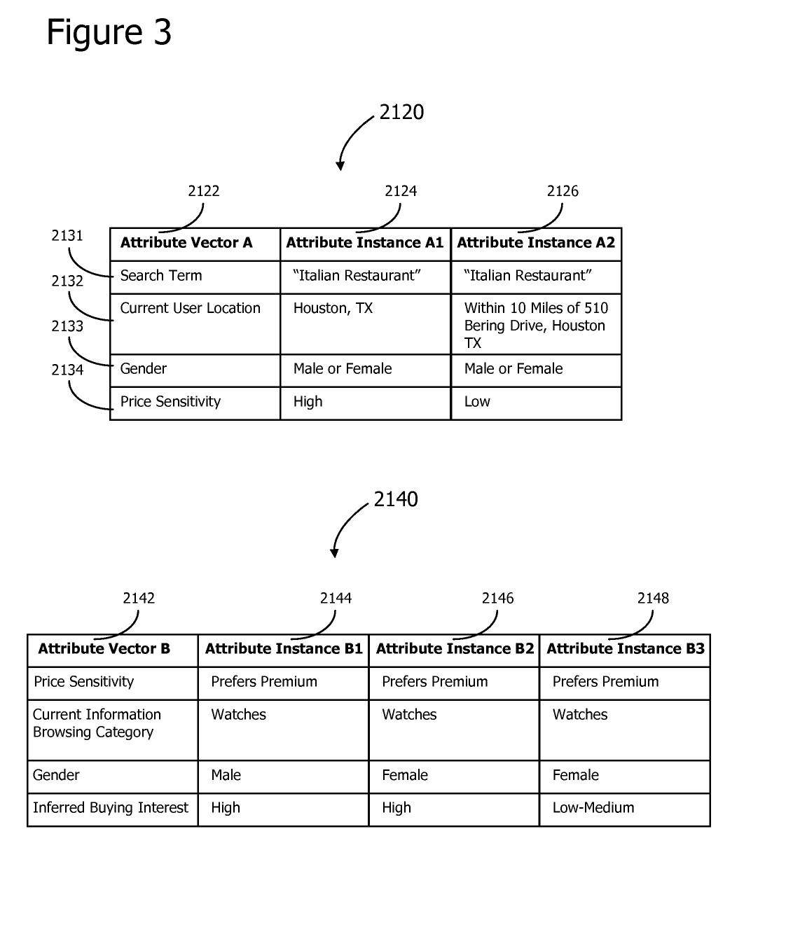

FIG. 3 provides pictorial representations of an attribute vector and associated attribute instances, which collectively may be termed an attribute vector/instance mapping. For example, attribute vector/instance mapping 2120 includes an Attribute Vector A 2122 with four attributes: Search Term 2131, Current User Location 2132, Gender 2133, and Price Sensitivity 2134. Mapped to Attribute Vector A 2122, are two attribute instances, Attribute Instance A1 2124 and Attribute Instance A2 2126. Each of the attribute instances 2124, 2126 have four attribute values, each corresponding to the associated attribute of Attribute Vector A1 2122.

In some cases the attribute values of Attribute Instance A1 2124 and Attribute Instance A2 2126 may have identical attribute values (for example, “Italian Restaurant” associated with the Search Term attribute of Attribute Vector A 2122). In other cases, the attribute values may be different (such as the attribute values corresponding to the Price Sensitivity attribute of Attribute Vector A 2122). Note that the differing attribute values may be mutually exclusive such as in the case of the attribute values associated with the Price Sensitivity attribute of Attribute Vector A 2122, or have some degree of overlap, or have a subset relationship, such as in the case of the attribute values associated with the Current User Location attribute of Attribute Vector A 2122.

FIG. 3 also depicts a second attribute vector/instance mapping 2140 that features a second attribute vector, Attribute Vector B. Attribute Vector B has three corresponding attribute instances, Attribute Instance B1 2144, Attribute Instance B2 2146, and Attribute Instance B3 2148. In this case, Attribute Vector B does not include a search term attribute. Rather, interactions or browsing of information (in this case, content related to watches) may trigger delivery of an advertisement associated with a corresponding attribute instance, assuming other attribute instance values are also satisfied.

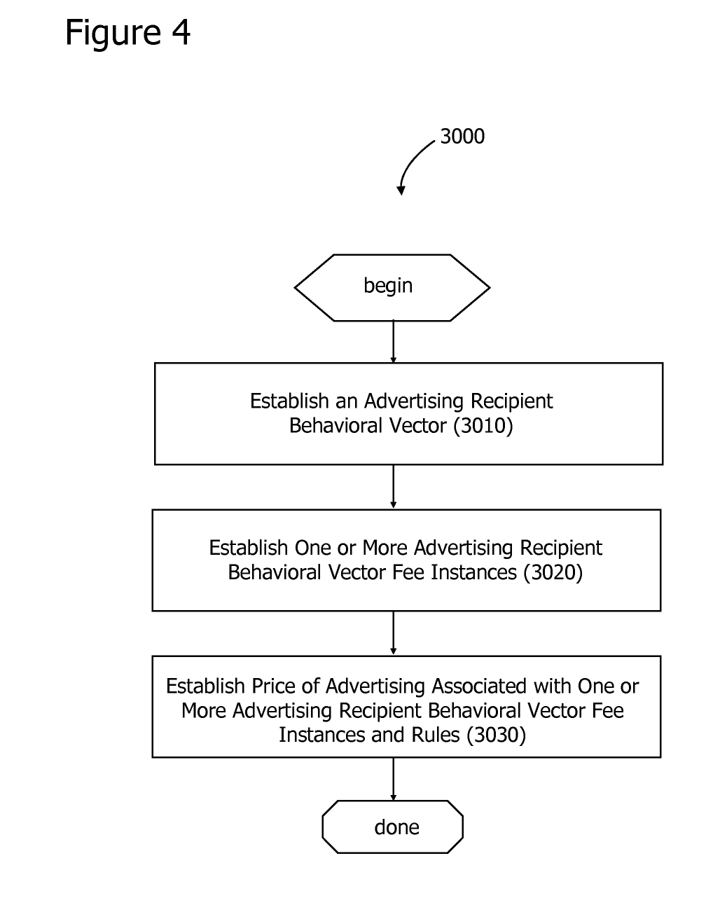

In accordance with some embodiments, FIG. 4 is a flow chart of the advertisement recipient behavior-based pricing process 3000 of the present invention that may be applied in conjunction with the multi-attribute and/or advertising recipient behavior pricing process 10 of FIG. 1, or may be applied independently of the multi-attribute and/or advertising recipient behavior pricing process 10 of FIG. 1

The process 3000 begins by establishing 2010 an advertising recipient behavior vector. An advertising recipient behavior vector includes one or more advertising recipient behavior types, and it should be understood that the term “behavior vector” as used herein may encompass any collection of one or more recipient behavior types. An example recipient behavior type associated with prior art advertising processes is a “click” on an advertisement (as used in “pay per click” advertising processes). The present invention extends beyond prior art to include, but is not limited to, applying the following ad recipient behavior types: product or service purchase, visiting a physical location of an advertiser, referencing or tagging an advertisement for future access, referring an advertisement to others, the duration of time spent on the advertisement's destination site (as directed by, for example, by a URL on the World Wide Web) or information associated with the advertisement, the accessing of, or interaction with, explanatory information related to why the recipient received the advertisement, and any other behavior type or category, including those described in Table 1 below.

The next step of process 3000 is the establishment of one or more advertising recipient behavior vector fee instances 3020. Each advertising recipient behavior vector fee instance has at least one fee, or more generally, a fee function, corresponding to at least one (or most generally, a subset) of the advertising recipient behavior types of the advertising recipient behavior vector. These fees are paid by the advertiser upon execution by the advertising recipient of one or more advertising recipient behaviors corresponding to one or more advertising vector subsets.

The specific fees or prices associated with one or more advertising recipient behavior vector fee instances and associated fee functions, in conjunction with optional associated pricing rules, are then established 3030. The fees may be a fixed amount per behavior (a constant function), or they may be a variable function of the corresponding behavior (for example, a percentage of a purchase made by an advertising recipient, or a function of the duration spent browsing at an advertisements destination site or referenced information, or a function of the number of referrals made). The fee may be established independently of the advertisement purchaser, or may be established in conjunction with one or more potential advertisement purchasers; as for example in a bidding or auction process.

In addition to defining fees associated one or more advertising recipient behavior vector fee instances and associated fee functions, logic, rules or functions may also be applied in step 3030 to support the calculation of total fees when an advertising recipient exhibits multiple behaviors. For example, an advertising recipient might spend a significant amount of time at an advertisement's destination site, the duration of which might have a corresponding fee. The advertising recipient might then refer the advertisement to several other individuals, and then actually buy a product at the advertising destination site. In such a case, the logic might determine which fees or fee functions supersede other fees, and which are independent of other fees. For example, an actual purchase behavior might supersede the duration spent at the destination site, since the purchase is the ultimate behavior desired by the advertiser; but the fee for referrals may also be charged regardless of the actual purchase behavior of the advertising recipient since the referral behavior generates potential for purchases by others, providing additional independent potential value to the advertiser.

Further, the fees may be determined against a set of advertising recipient behaviors that are executed by a user within a defined limit, such as a session limit, or a time limit. For example, in some applications, the behaviors corresponding to a specific fee basis may need to all be conducted with a single “session”, where a session constitutes a specific browser session, or session may be defined by a log-in or log-out sequence by the user associated with an computer operating system or other computer-based system. Or a time limit may be invoked with regard to a specific fee basis associated with advertising recipient behaviors that may apply within or across sessions. For example, one day or one week limits may apply.

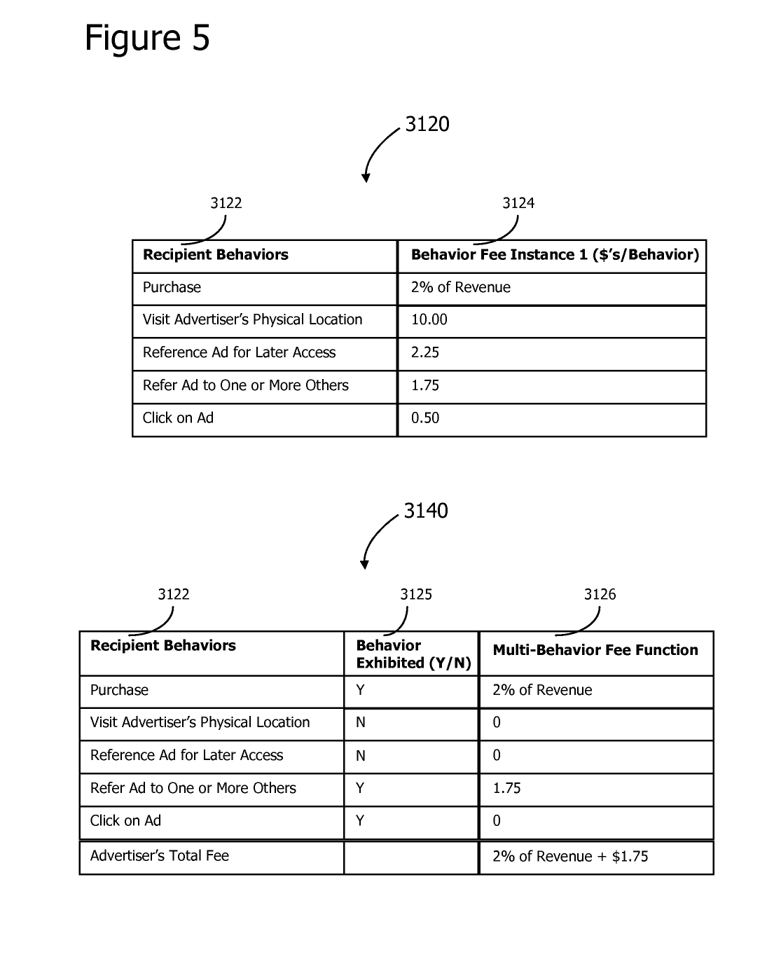

FIG. 5 provides a pictorial illustration of an advertising recipient behavior and fee mapping 3120. The mapping 3120 includes a vector of ad recipient behaviors 3122, in this case a purchase behavior, a visitation to an advertiser's physical location behavior, a referencing of the ad for later access behavior, a referral of the ad to others behavior, and a click on the ad behavior. Associated with the ad recipient behavior vector 3122 is an ad recipient behavior vector fee instance 1 3124. The ad recipient behavior vector fee instance 1 3124 includes fees corresponding to a behavior. For example, referencing or tagging the ad for later recall or access is priced at 2.25 cents.

In accordance with some embodiments, FIG. 5 also depicts 3140 a multi-behavior fee function as applied to a subset of a vector of behavior types 3122 corresponding to actual ad recipient behaviors. The example 3140 depicts a situation in which an advertising recipient exhibits a subset 3125 of behaviors associated with a behavior vector 3122. In the example 3140, as indicated by the “Y's” in the behavior exhibited vector 3125, an advertising recipient exhibits three behaviors after receiving an ad: a click on the ad, a referral of the ad to others, and a purchase of a product or service from the advertiser. (The behaviors may be within a specific computer session, or may be tracked across more than one computer session.) As shown in the multi-behavior fee function column 3126, behaviors which were not exhibited by the ad recipient do not contribute to a total advertising fee. In addition, in this example, behaviors that are superseded by a more valuable behavior to the advertiser may not contribute to a total advertising fee. In this case, the click on the ad does not contribute to a total advertising fee as at least one other behavior, and actual purchase behavior, is more valuable to the advertiser. Therefore, in this example the total advertising fee is a combination of a variable function of the magnitude of the purchase (2% of revenue) and a fixed value for referring an ad to others ($1.75).

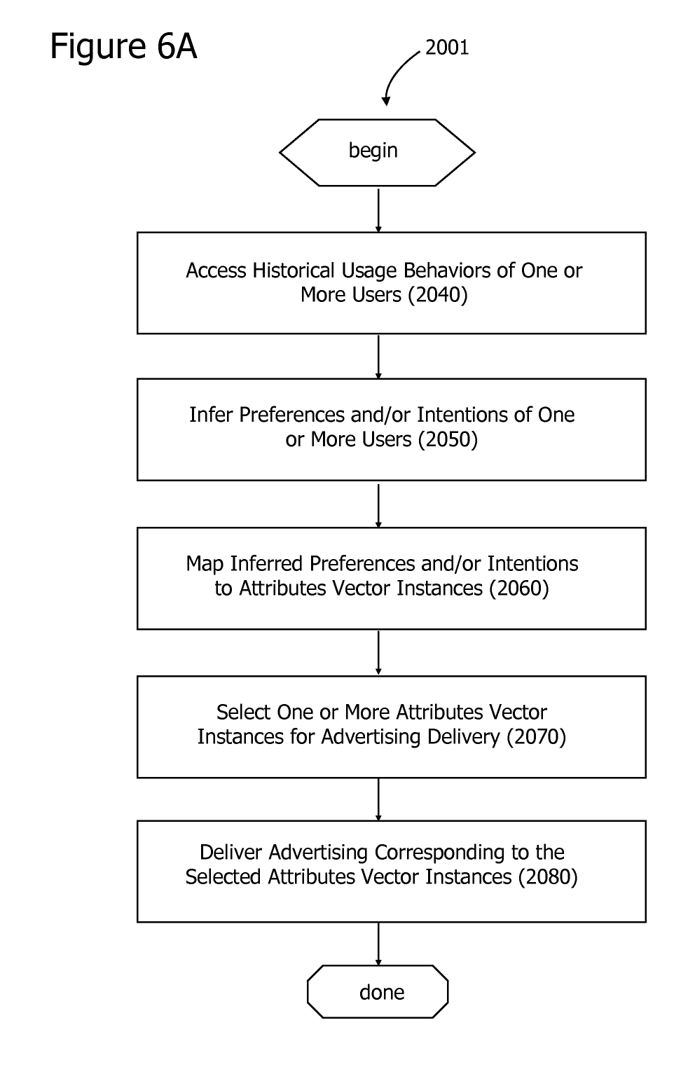

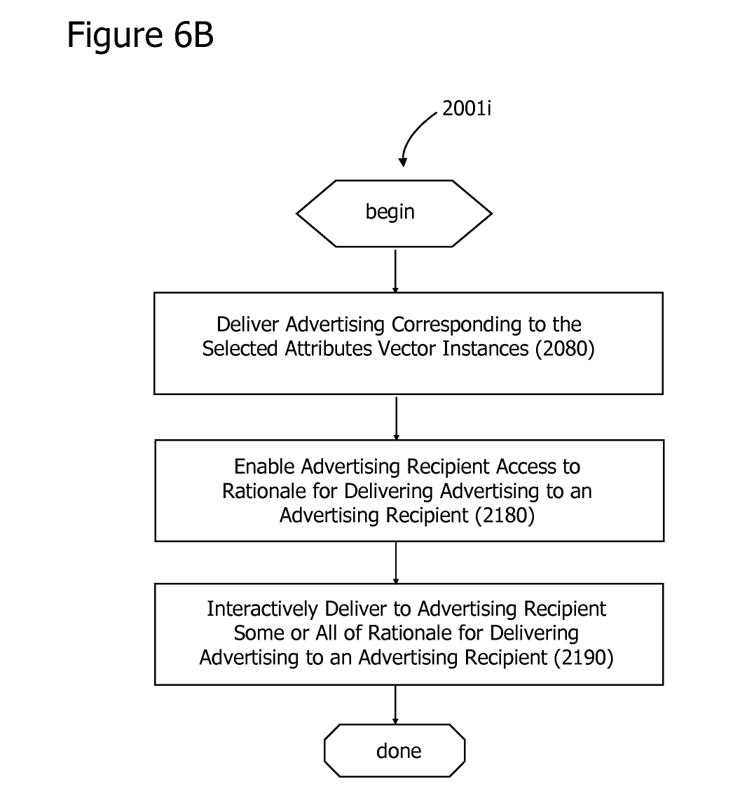

In accordance with some embodiments, FIG. 6A is a flow diagram of a process 2001 of delivering multi-attribute advertising to ad recipients. The first process step 2040 is to access usage behaviors of one or more users 2040 of one or more computer-based systems. Usage behaviors are defined in detail below, but may include computer-based accesses, purchasing history, search term and/or search history, collaborative behaviors with others, and self-profiling or profiling by third parties. Usage behaviors may also include monitored behaviors, such as the physical location of a user, or the locations over time, and/or physiological responses of users, and/or environmental conditions external to the user.

Applying the usage behavior information of one or more users 2040, inferences on the preferences, qualifications, and/or intentions of one or more users are derived 2050. One or more algorithms may be applied to derive the inferences associated with expected preferences, interests, and/or intentions. The algorithms may employ statistical inferencing models, and/or logical or statistical rules of induction or deduction.

The inferred preferences and/or intentions or intentions are then mapped to one or more attribute vector instances 2060. For example, if a user searched for “Italian Restaurant”, and the current location of the user was determined by a location-aware system (e.g., global positioning system), or through manual input of the location by the user, that the user was currently 7.4 miles from 510 Bering Drive, Houston, Tex., and that based on usage behaviors, including, for example, purchase history, that the user was relatively insensitive to price, then these inferred usage behaviors would match the attribute vector instance example of expression (4) above. In general, the inferred preferences and/or intentions or intentions may map to, or match, multiple attribute vector instances.

The next process step 2070 of process 2001 is the selection of the one or more attribute vector instances for which an advertisement will be delivered. This may typically be all the matched attribute vector instances. However, logic may be applied in process step 2070 to suppress selection of one or more attribute vector instances. This may be based on considerations on the number of ads that would be delivered to a particular ad recipient, or may be based on inferences on how relatively well the ad recipient's preferences and/or intentions match the entire attribute vector instance.

Advertising that corresponds to selected attribute vector instances is then delivered to the one or more advertising recipients 2080. The advertising may be delivered through a computer-based system, such as through an Internet session. For example, the advertisements may be co-displayed with the results of a search query, or in response to any other user interaction with the computer-based system, or any monitored behavior (e.g., change in physical location). Or the advertising may be delivered in non-electronic format, such as within printed media. The advertising may take any form, including visual or audio, or a combination thereof. Further, the advertising may be delivered within digital forms such as digitized simulations of radio or television broadcasts (e.g., podcasts), digitized books, or any other digitized media. Thus, advertising may be delivered in real-time to an advertising recipient, or delivered in a format that can be “consumed” by the advertising recipient at a later time, and potentially be “consumed” more than once.

Transparent Delivery Rationale Advertisement Delivery Process

When an advertisement or marketing action is delivered to an ad recipient, the ad recipient either consciously or unconsciously often naturally wonders why he or she is receiving the ad or otherwise being marketed to. If the answer to that question is quickly provided in a way that the recipient perceives as positive, the associated ad or marketing action is more likely to be effective. In fact, the ad delivery rationale may contribute to “need awareness”—highlighting to the recipient why they are likely to find the product or service associated with the advertisement valuable.

For example, the more the recipient of an ad feels the ad is very well targeted, the more “special” the recipient will feel—this can be the case even though the ad and the rationale for the ad being delivered to the recipient are generated automatically by a computer-based system. Being made to feel special can be a powerful inducement for the ad recipient to exhibit behaviors desired by the advertiser or marketer.

Furthermore, detailed and convincing ad delivery rationale can serve to make the advertisement be perceived by the ad recipient as more authoritative and/or credible. Promoting a recipient feeling of being treated as special and/or promoting a degree of advertising authority and credibility can have a strong positive psychological effect on prospective buyers, and these capabilities of promoting such feelings by the ad recipient are missing in prior art on-line advertising methods and systems.

In accordance with some embodiments, FIG. 6B is a flow diagram of a process 2001i for a transparent delivery rationale method associated with multi-attribute advertising delivery.

In the first step of transparent ad delivery rationale process 2001i, advertising is delivered 2080 in accordance with the multi-attribute advertising delivery process 2000 of FIG. 6A.

In the second step of transparent ad delivery rationale process 2001i, advertising recipient access of the rationale for delivering advertising to an advertising recipient is enabled 2180. The enablement 2180 may take the form of an icon, button, or any other visual or audio cue that invites the ad recipient to understand the rationale for delivery of the associated ad. In some embodiments, some or all of the rationale may be co-displayed or, more generally, co-expressed, with the advertisement itself. Where just some of the rationale is displayed, the ad recipient may be enabled to see further details of the rationale if the ad recipient desires.

In the third step of transparent ad delivery rationale process 2001i, interactive delivery of the rationale for delivering advertising to an advertising recipient is performed 2190. The interactive delivery 2190 may constitute a single step procedure of delivering the rationale, or it may be iterative, with more details of the rationale of being delivered to the ad recipient upon request. The delivery of the rationale may be in the form of natural language (e.g., English sentences), or may be in a tabular, matrix, and/or graphical form.

The form and method of delivery of the rationale may itself be personalized based on inferred preferences and/or interests of the ad recipient. For example, if is inferred that an ad recipient responds better to an ad in which the text is of a certain language, then the text of the ad rationale itself would be most appropriately delivered in that language. Or, as another example, if the ad recipient responds better to more visually-based ads, then the ad rationale would be most appropriately delivered with an emphasis on visual information.

The transparent ad delivery rationale process 2001i ends when the ad recipient completes his or her queries or interactions regarding the rationale associated with an ad that was delivered to the ad recipient.

Applying Preferences and Interests Inferences to Optimize the Advertisement Delivery and Experience

In conjunction with the multi-attribute advertising deliver process 2001 of FIG. 6A, in some embodiments advertisers may strive to increase their response rates to advertising by applying inferred attributes, preferences, interests, and/or intentions of ad recipients to dynamically select, compile or optimize an advertisement itself for delivery, not just optimize the selection an advertisement for delivery. For example, an advertising recipient who is of a particular ethnicity and has a family of two school age children that is researching the purchase of a new car may respond better to an advertisement that includes imagery, sound or other cues that help the recipient identify with or better picture themselves and/or other influential individuals involved in the buying decision in the context of the product or service to be purchased. Given this, advertisers in some embodiments may wish to have personalized variations of advertisements delivered to ad recipients that are optimized for the inferred attributes of advertising recipients. Such personalized variations of advertisements may be predetermined and then selected based on inferred ad recipient attributes, or they may be dynamically generated from advertisement components that are aligned with the specific inferred attributes of the ad recipient.

In some embodiments, the process step “deliver advertising corresponding to the selected attributes vector instances” 2080 of processes 2001 or 2001i may select and/or assemble advertising components into a advertisement that is to be delivered, where the components represent parts of advertisement that are variations on a particular theme. Variations of a theme as represented by one or more advertisement components may include: a) for text based advertising, e.g. choice of words, references to or by spokespersons (such as influential people, not limited to actors, pop stars, sports players, politicians, commentators) amount of words, selection of words (which may be based on recipients' previous response to ads), language, idioms or vocabulary; b) for visual or audio based advertising, e.g. choice of narrator or presenter (live or animated), appearance of people included in the advertising (not limited to race, popularity, age, height, weight, style of dress), method of engagement (perceived personal style characteristics such as levels of professionalism, friendliness, manner of speech, grammar and choice of words), selection of background or context for the ad (including level of familiarity—e.g., “looks like home” of the advertising recipient or other locales pertinent to the subject of the ad).

In some embodiments, the selection history of the advertisement components that are used to compile or optimize advertisements are stored in the system, so that hypothesis testing and experimentation from the reaction of advertising recipients can be tracked and further used for optimization in the future.

Advertising Recipient Behavior Processing

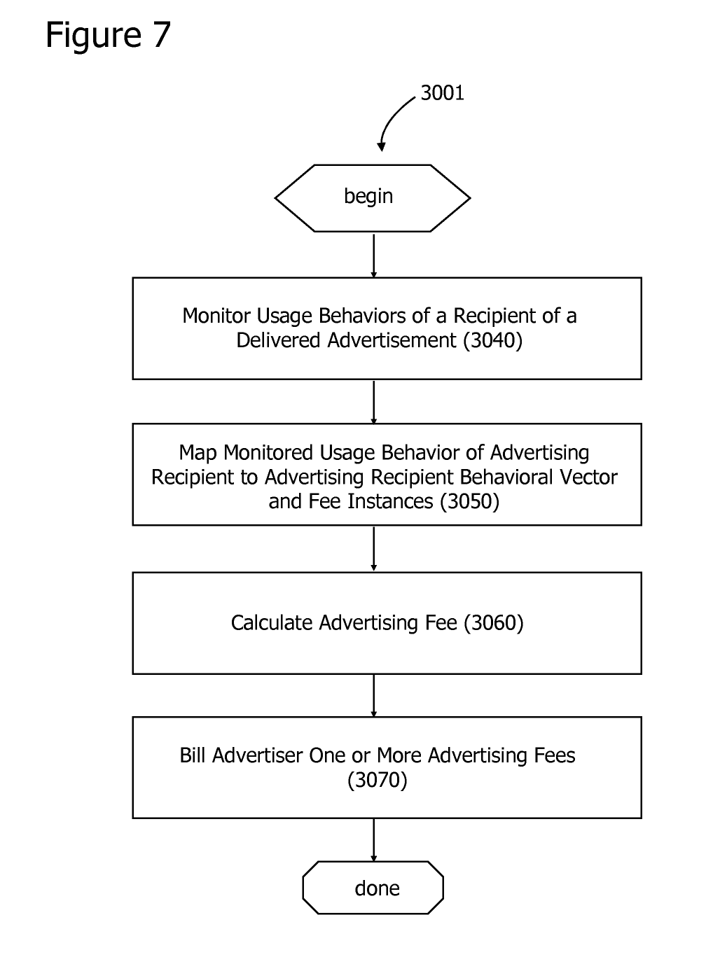

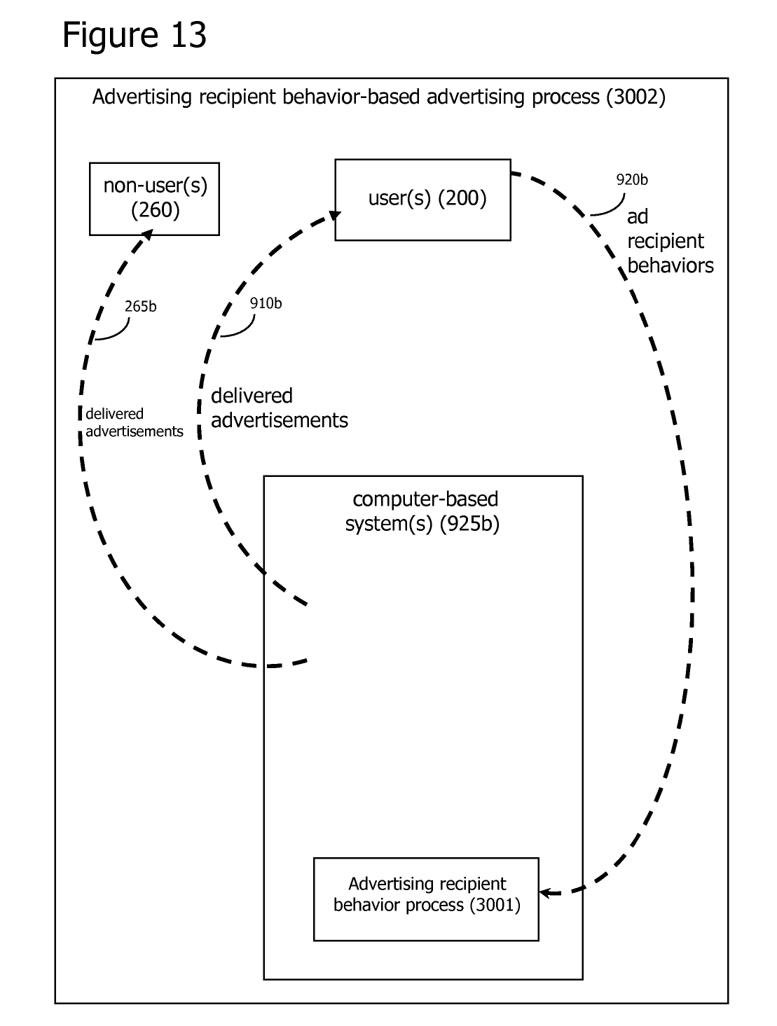

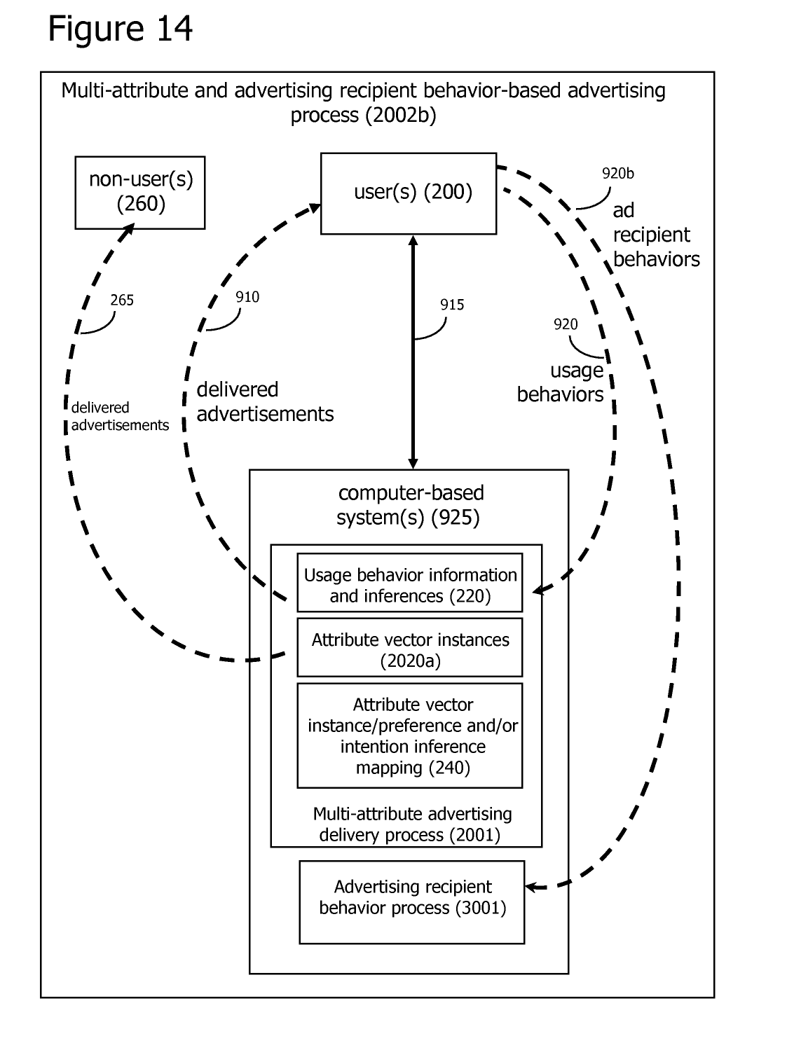

In accordance with some embodiments, FIG. 7 is a flow diagram of advertising recipient behavior processing 3001. Upon delivery of an advertisement to an advertising recipient, which may be in accordance with the multi-attribute advertising delivery 2080 of multi-attribute advertising delivery process 2001, one or more usage behaviors 920b (see FIGS. 13 and 14) of the advertising recipient are monitored 3040. The one or more monitored usage behaviors 920b may include, but are not limited to, the behaviors listed in Table 1 below. The behaviors 920b and may be within a specific user session, and may be in conjunction with an anonymous user, or may be in conjunction with a user that is identified through an authentication process. Tracking of advertising recipient behaviors 920b of identified users 200 may enable tracking of behaviors across individual computer sessions, where appropriate.

The one or more monitored usage behaviors 920b are then mapped 3050 to an advertising recipient behavior vector and associated fee instance 3120. If the mapping results in at least one fee, an advertising fee is calculated 3060. The advertising fee calculation may apply logic or rules defined in the “establish price of advertising of one or more advertising recipient vector fee instances and rules' 3030 step of the advertisement recipient behavior-based pricing process 3000. An algorithm may be applied in “the calculate advertising fee” 3060 step of process 3001 to resolve cases in which multiple behaviors correspond to multiple fees. In some cases, fees associated with certain behaviors 920b will be additive, in other cases some fees 3124 associated with corresponding behaviors 920b will supersede other fees 3124, and in other cases, some other function than supercession or strict addition may be applied to resolve multiple behavioral fees 3124 to calculate a total fee to the advertiser.

The advertiser is then billed 3070 for one or more of the total fees associated with one or more ad recipients. The fees may be aggregated over some period of time (e.g., monthly) prior to the billing or invoicing.

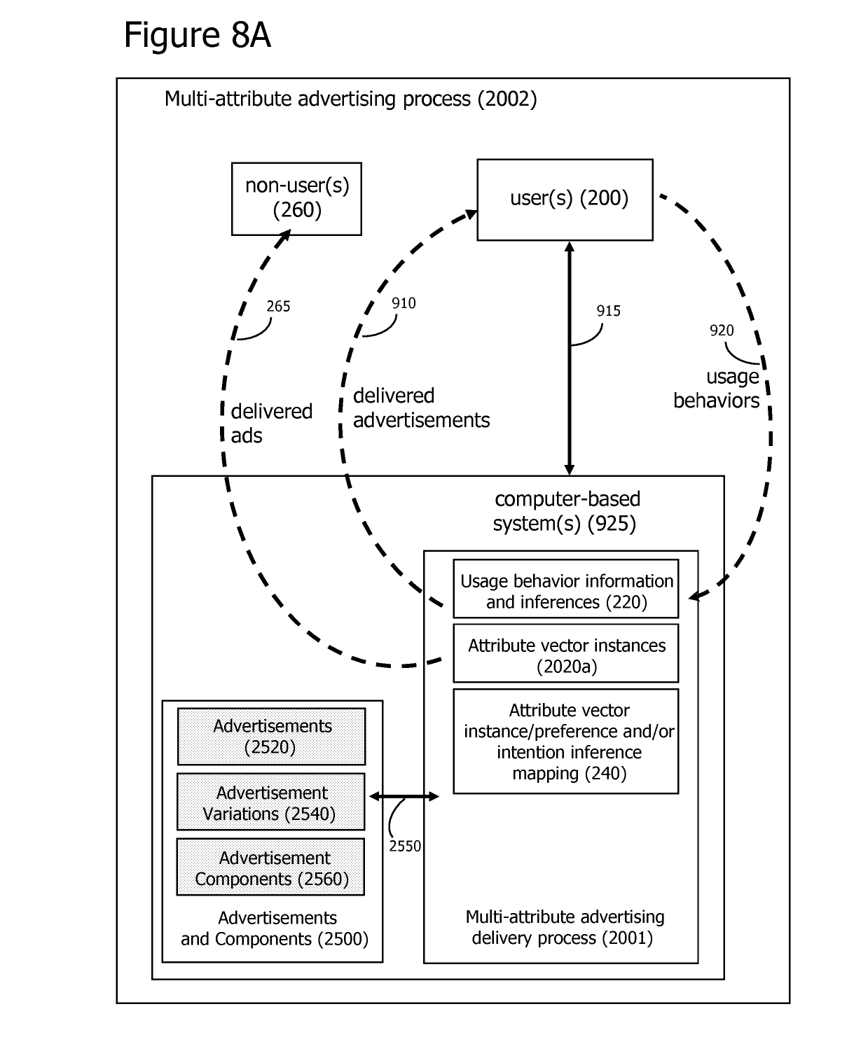

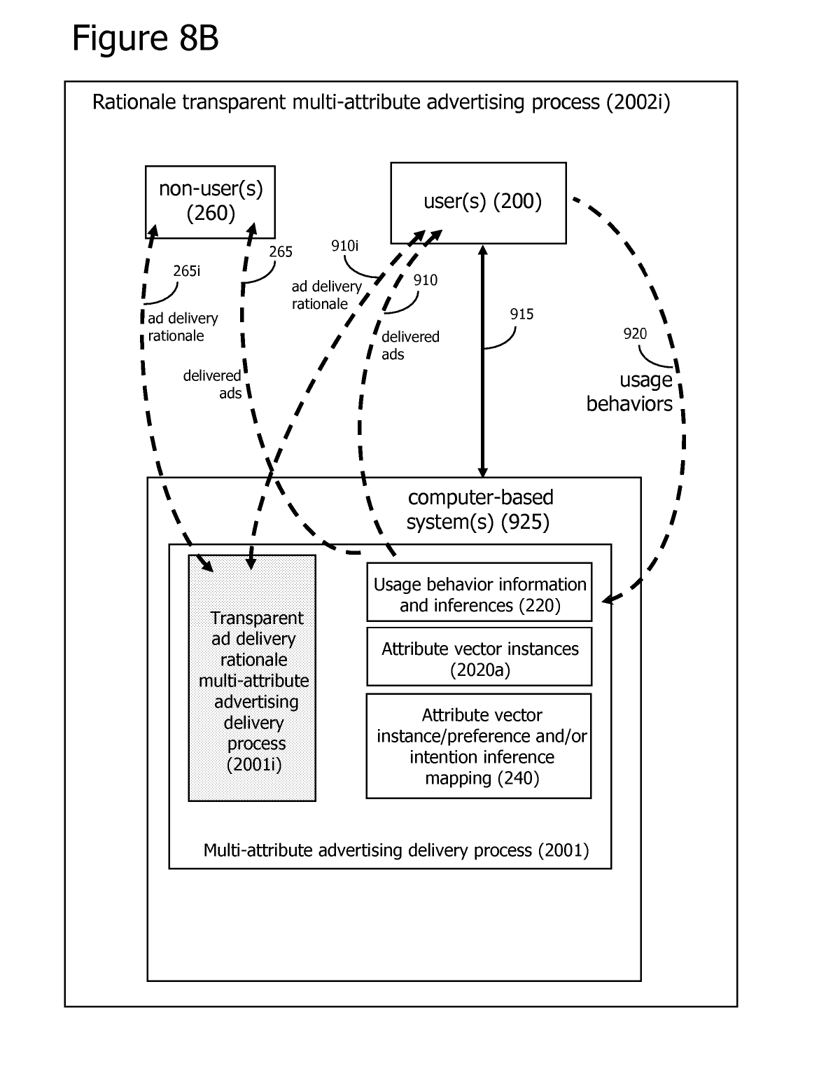

FIG. 8A represents a summary schematic of a computer-based multi-attribute advertising process 2002. One or more users 200 interact 915 with one or more computer-based systems 925. The interactions 915 may be in conjunction with navigating the systems, performing a search, or any other usage behavior, including, but not limited to, those referenced by the usage behavior categories of Table 1. Selective usage behaviors 920 associated with the one or more users 200 are accessible by the one or more computer based systems 925. The one or more computer-based systems 925 includes functions to execute some or all of the steps of multi-process advertising delivery process 2001 of FIG. 6A. The computer-based process 2001 of FIG. 8A includes a function to manage usage behavior information and inferences on user preferences and/or intentions 220 (corresponding to the steps of “Accessing Historical Usage Behaviors of One or More users 2040 and “Infer Preferences and/or Intentions of One or More Users” in FIG. 6A), a function that manages attribute vector instances 2020a, and a function that maps one or more attribute vector instances with one of more user preference and/or intention inferences 240 (corresponding to the step of “Map Inferred Preferences and/or Intentions to Attributes Vector Instances” 2060 of FIG. 6A).

The one or more computer-based systems 925 may contain advertisements and components 2500 that are accessible 2550 by multi-attribute advertising delivery process 2001. The advertisements and components have correspondences to attribute vector instances 2020a, which enables multi-attribute advertising process 2001 to select the appropriate advertisement for a given attribute vector instance/behavior that corresponds to an ad recipient preference and/or intention inference as determined by function 240.

Advertisements and components 2500 may include self-contained advertisements 2520, and/or may include advertisement variations 2540 that are frameworks or templates that are filled in or completed through selection of advertisement components 2560 consistent with inferred preferences or intentions of the ad recipient by the multi-attribute advertising delivery process 2001. For example, a general video-based advertisement variation 2540 many be supplemented with an audio component within advertisement components 2560 of a language consistent with the inferred preferences of the ad recipient.

The one or more computer-based systems 925 deliver advertisements 910 to the one or more users 200 based on the mapping of attribute vector instances and usage behavior information and/or inferences 240. It should be understood that advertising may be delivered 265 to advertising recipients 260 that are not current and/or historic users 200 of the one or more computer-based systems 925.

In accordance with some embodiments, FIG. 8B represents a summary schematic of a rationale transparent multi-attribute advertising process 2002i, which is a variation of multi-attribute advertising process 2002 of FIG. 8A, wherein the rationale for the delivery of the ad to the ad recipient is accessible by the ad recipient.

In the rationale transparent multi-attribute advertising process 2002i, one or more users 200 interact 915 with one or more computer-based systems 925. The interactions 915 may be in conjunction with navigating the systems, performing a search, or any other usage behavior, including, but not limited to, those referenced by the usage behavior categories referenced by Table 1. Selective usage behaviors 920 associated with the one or more users 200 are accessible by the one or more computer based systems 925. The one or more computer-based systems 925 include the multi-process advertising delivery process 2001 of FIG. 6A, which includes a function to manage usage behavior information and inferences on user preferences and/or intentions 220, a function that manages attribute vector instances 2020a, and a function that maps one or more attribute vector instances with one of more user preference and/or intention inferences 240.

The one or more computer-based systems 925 also includes the transparent delivery rationale multi-process advertising delivery process 2001i of FIG. 6A, and which includes one or more functions to enable access to, and/or interaction with, of some or all of the rationale for delivery of an ad to an advertising recipient.

The transparent delivery rationale multi-process advertising delivery process 2001i of the one or more computer-based systems 925 delivers 910i some or all of the rationale for the delivery of the advertisements to the one or more users 200 based on the mapping of attribute vector instances and inferred ad recipient preferences and/or intentions 240. It should be understood that some or all of the rationale for the delivery of the advertisements may be delivered 265i to advertising recipients 260 that are not current and/or historic users 200 of the one or more computer-based systems 925.

The transparent delivery rationale multi-process advertising delivery process 2001i may include one or more functions to enable interactive ad rationale delivery 910i, 265i. The display means of the interaction may generate text, graphics, audio or combinations thereof to deliver some or all of the rationale of advertisement delivery to the ad recipient. For textual display means, the rationale delivery may be in the form of natural language.

User Behavior Categories

In Table 1, several different user behaviors 920, which may also be described as process “usage” behaviors without loss of generality, are identified by the one or more computer-based systems 925 and categorized. The usage behaviors 920 may be associated with the entire community of users, one or more sub-communities, or with individual users or users of the one of more computer-based applications 925. The usage behaviors described in Table 1 and the accompanying descriptions may apply to a priori systems use 920 (that is, prior to the delivery of an advertisement) or behaviors exhibited after receiving an advertisement 920b.

TABLE 1
Usage behavior categories and usage behaviors

| usage behavior | |
|---|---|
| category | usage behavior examples |
| navigation | activity, content and computer application |
| and access | accesses, including buying/selling |
| | paths of accesses or click streams |
| | execution of searches and/or search history |
| subscription | personal or community subscriptions to |
| and self-profiling | process topical areas |
| | interest and preference self-profiling |
| | affiliation self-profiling (e.g., job function) |
| collaborative | referral to others |
| | discussion forum activity |
| | direct communications (voice call, messaging) |
| | content contributions or structural alterations |
| reference | personal or community storage and tagging |
| | personal or community organizing of stored or |
| | tagged information |
| direct feedback | user ratings of activities, content, computer |
| | applications and automatic recommendations |
| | user comments |
| physiological | direction of gaze |
| responses | brain patterns |
| | blood pressure |
| | heart rate |
| environmental | current location |
| conditions and | location over time |
| location | relative location to users/object references |
| | current time |
| | current weather condition |

A first category of process usage behaviors 920 is known as system navigation and access behaviors. System navigation and access behaviors include usage behaviors 920 such as accesses to, and interactions with computer-based applications and content such as documents, Web pages, images, videos, TV channels, audio, radio channels, multi-media, interactive content, interactive computer applications, e-commerce applications, or any other type of information item or system “object.” These process usage behaviors may be conducted through use of a keyboard, a mouse, oral commands, or using any other input device. Usage behaviors 920 in the system navigation and access behaviors category may include, but are not limited to, the viewing or reading of displayed information, typing written information, interacting with online objects orally, or combinations of these forms of interactions with computer-based applications. This category includes the explicit searching for information, using, for example, a search engine. The search term may be in the form of a word or phrase to be matched against documents, pictures, web-pages, or any other form of on-line content. Alternatively, the search term may be posed as a question by the user.

System navigation and access behaviors may also include executing transactions, including commercial transactions, such as the buying or selling of merchandise, services, or financial instruments. System navigation and access behaviors may include not only individual accesses and interactions, but the capture and categorization of sequences of information or system object accesses and interactions over time.

A second category of usage behaviors 920 is known as subscription and self-profiling behaviors. Subscriptions may be associated with specific topical areas or other elements of the one or more computer-based systems 925, or may be associated with any other subset of the one or more computer-based systems 925. Subscriptions may thus indicate the intensity of interest with regard to elements of the one or more computer-based systems 925. The delivery of information to fulfill subscriptions may occur online, such as through electronic mail (email), on-line newsletters, XML feeds, etc., or through physical delivery of media.

Self-profiling refers to other direct, persistent (unless explicitly changed by the user) indications explicitly designated by the one or more users regarding their preferences and/or intentions and interests, or other meaningful attributes. A user 200 may explicitly identify interests or affiliations, such as job function, profession, or organization, and preferences and/or intentions, such as representative skill level (e.g., novice, business user, advanced). Self-profiling enables the one or more computer-based systems 925 to infer explicit preferences and/or intentions of the user. For example, a self-profile may contain information on skill levels or relative proficiency in a subject area, organizational affiliation, or a position held in an organization. A user 200 that is in the role, or potential role, of a supplier or customer may provide relevant context for effective adaptive e-commerce applications through self-profiling. For example, a potential supplier may include information on products or services offered in his or her profile. Self-profiling information may be used to infer preferences and/or intentions and interests with regard to system use and associated topical areas, and with regard to degree of affinity with other user community subsets. A user may identify preferred methods of information receipt or learning style, such as visual or audio, as well as relative interest levels in other communities.

A third category of usage behaviors 920 is known as collaborative behaviors. Collaborative behaviors are interactions among the one or more users. Collaborative behaviors may thus provide information on areas of interest and intensity of interest. Interactions including online referrals of elements or subsets of the one or more computer-based systems 925, such as through email, whether to other users or to non-users, are types of collaborative behaviors obtained by the one or more computer-based systems 925.

Other examples of collaborative behaviors include, but are not limited to, online discussion forum activity, contributions of content or other types of objects to the one or more computer-based systems 925, or any other alterations of the elements, objects or relationships among the elements and objects of one or more computer-based systems 925. Collaborative behaviors may also include general user-to-user communications, whether synchronous or asynchronous, such as email, instant messaging, interactive audio communications, and discussion forums, as well as other user-to-user communications that can be tracked by the one or more computer-based systems 925.

A fourth category of process usage behaviors 920 is known as reference behaviors. Reference behaviors refer to the marking, designating, saving or tagging of specific elements or objects of the one or more computer-based systems 925 for reference, recollection or retrieval at a subsequent time. Tagging may include creating one or more symbolic expressions, such as a word or words, associated with the corresponding elements or objects of the one or more computer-based systems 925 for the purpose of classifying the elements or objects. The saved or tagged elements or objects may be organized in a manner customizable by users. The referenced elements or objects, as well as the manner in which they are organized by the one or more users, may provide information on inferred interests of the one or more users and the associated intensity of the interests.

A fifth category of process usage behaviors 920 is known as direct feedback behaviors. Direct feedback behaviors include ratings or other indications of perceived quality by individuals of specific elements or objects of the one or more computer-based systems 925, or the attributes associated with the corresponding elements or objects. The direct feedback behaviors may therefore reveal the explicit preferences and/or intentions of the user. In the one or more computer-based systems 925, the advertisements 910 may be rated by users 200. This enables a direct, adaptive feedback loop, based on explicit preferences and/or intentions specified by the user. Direct feedback also includes user-written comments and narratives associated with elements or objects of the computer-based system 925.

A sixth category of process usage behaviors is known as physiological responses. These responses or behaviors are associated with the focus of attention of users and/or the intensity of the intention, or any other aspects of the physiological responses of one or more users 200. For example, the direction of the visual gaze of one or more users may be determined. This behavior can inform inferences associated with preferences and/or intentions or interests even when no physical interaction with the one or more computer-based systems 925 is occurring. Even more direct assessment of the level of attention may be conducted through access to the brain patterns or signals associated with the one or more users. Such patterns of brain functions during participation in a process can inform inferences on the preferences and/or intentions or interests of users, and the intensity of the preferences and/or intentions or interests. The brain patterns assessed may include MRI images, brain wave patterns, relative oxygen use, or relative blood flow by one or more regions of the brain.

Physiological responses may include any other type of physiological response of a user 200 that may be relevant for making preference or interest inferences, independently, or collectively with the other usage behavior categories. Other physiological responses may include, but are not limited to, utterances, gestures, movements, or body position. Attention behaviors may also include other physiological responses such as breathing rate, heart rate, blood pressure, or galvanic response.

A seventh category of process usage behaviors is known as environmental conditions and physical location behaviors. Physical location behaviors identify physical location and mobility behaviors of users. The location of a user may be inferred from, for example, information associated with a Global Positioning System or any other positionally or locationally aware system or device, or may be inferred directly from location information input by a user (e.g., a zip code or street address), or otherwise acquired by the computer-based systems 925. The physical location of physical objects referenced by elements or objects of one or more computer-based systems 925 may be stored for future reference. Proximity of a user to a second user, or to physical objects referenced by elements or objects of the computer-based application, may be inferred. The length of time, or duration, at which one or more users reside in a particular location may be used to infer intensity of interests associated with the particular location, or associated with objects that have a relationship to the physical location. Derivative mobility inferences may be made from location and time data, such as the direction of the user, the speed between locations or the current speed, the likely mode of transportation used, and the like. These derivative mobility inferences may be made in conjunction with geographic contextual information or systems, such as through interaction with digital maps or map-based computer systems. Environmental conditions may include the time of day, the weather, lighting levels, sound levels, and any other condition of the environment around the one or more users 200.

In addition to the usage behavior categories depicted in Table 1, usage behaviors may be categorized over time and across user behavioral categories. Temporal patterns may be associated with each of the usage behavioral categories. Temporal patterns associated with each of the categories may be tracked and stored by the one or more computer-based systems 925. The temporal patterns may include historical patterns, including how recently an element, object or item of content associated with one or more computer-based systems 925. For example, more recent behaviors may be inferred to indicate more intense current interest than less recent behaviors.

Another temporal pattern that may be tracked and contribute to preference inferences that are derived, is the duration associated with the access or interaction with the elements, objects or items of content of the one or more computer-based systems 925, or the user's physical proximity to physical objects referenced by system objects of the one or more computer-based systems 925, or the user's physical proximity to other users. For example, longer durations may generally be inferred to indicate greater interest than short durations. In addition, trends over time of the behavior patterns may be captured to enable more effective inference of interests and relevancy. Since delivered advertisements 910 may include one or more elements, objects or items of content of the one or more computer-based systems 925, the usage pattern types and preference inferencing may also apply to interactions of the one or more users with the delivered advertisements 910 themselves, including accesses of, or interactions with, explanatory information regarding the logic or rational that the one more computer-based systems 925 used in deliver the advertisement 910 to the user.

User Behavior and Usage Framework

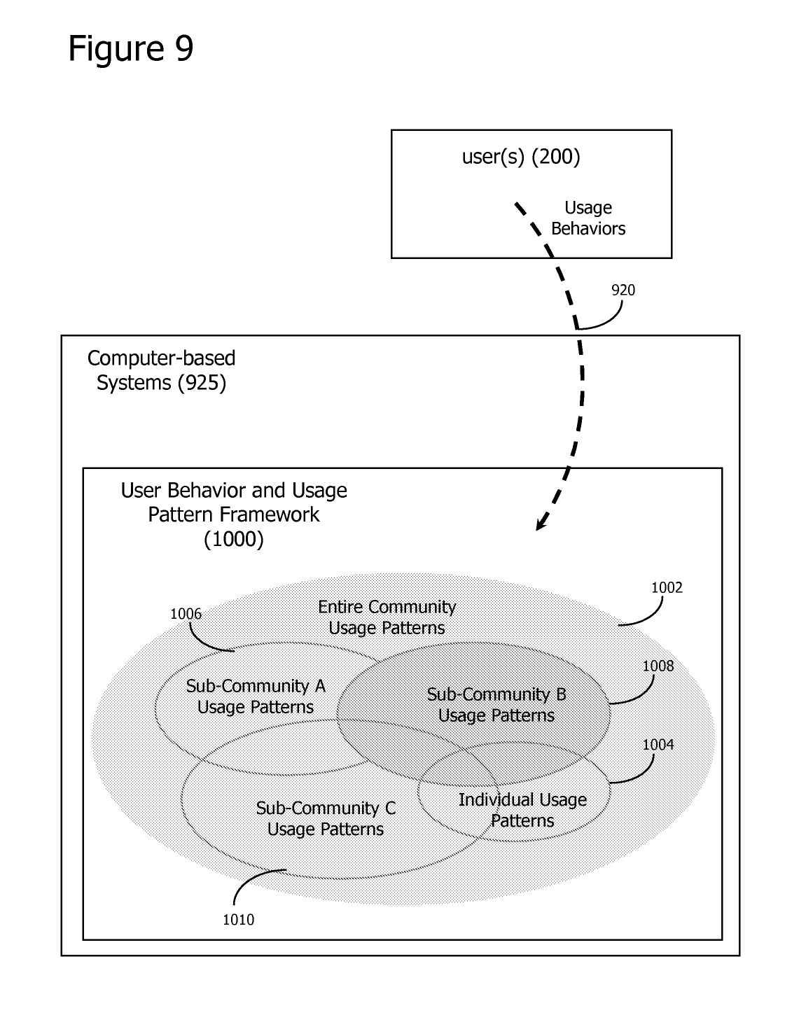

FIG. 9 depicts a usage framework 1000 for performing preference and/or intention inferencing of tracked or monitored usage behaviors 920 by the one or more computer-based systems 925. The usage framework 1000 summarizes the manner in which usage patterns are managed within the one or more computer-based systems 925. Usage behavioral patterns associated with an entire community, affinity group, or segment of users 1002 are captured by the one or more computer-based systems 925. In another case, usage patterns specific to an individual, shown in FIG. 9 as individual usage patterns 1004, are captured by the one or more computer-based systems 925. Various sub-communities of usage associated with users may also be defined, as for example “sub-community A” usage patterns 1006, “sub-community B” usage patterns 1008, and “sub-community C” usage patterns 1010.

Memberships in the communities are not necessarily mutually exclusive, as depicted by the overlaps of the sub-community A usage patterns 1006, sub-community B usage patterns 1008, and sub-community C usage patterns 1010 (as well as and the individual usage patterns 1004) in the usage framework 1000. Recall that a community may include a single user or multiple users. Sub-communities may likewise include one or more users. Thus, the individual usage patterns 1004 in FIG. 9 may also be described as representing the usage patterns of a community or a sub-community. For the one or more computer-based systems 925, usage behavior patterns may be segmented among communities and individuals so as to effectively enable adaptive advertising delivery 910 for each sub-community or individual.

The communities identified by the one or more computer-based systems 925 may be determined through self-selection, through explicit designation by other users or external administrators (e.g., designation of certain users as “experts”), or through automatic determination by the one or more computer-based systems 925. The communities themselves may have relationships between each other, of multiple types and values. In addition, a community may be composed not of human users, or solely of human users, but instead may include one or more other computer-based systems, which may have reason to interact with the one or more computer-based systems 925. Or, such computer-based systems may provide an input into the one or more computer-based systems 925, such as by being the output from a search engine. The interacting computer-based system may be another instance of the one or more computer-based systems 925.

The usage behaviors 920 included in Table 1 may be categorized by the one or more computer-based systems 925 according to the usage framework 1000 of FIG. 9. For example, categories of usage behavior may be captured and categorized according to the entire community usage patterns 1002, sub-community usage patterns 1006, and individual usage patterns 1004. The corresponding usage behavior information may be used to infer preferences and/or intentions and interests at each of the user levels.

Multiple usage behavior categories shown in Table 1 may be used by the one or more computer-based systems 925 to make reliable inferences of the preferences and/or intentions and/or intentions of a user with regard to elements, objects, or items of content associated with the one or more computer-based systems 925. There are likely to be different preference inferencing results for different users.

By introducing different or additional behavioral characteristics, such as the duration of access of an item of content, on which to base updates to the structure of one or more computer-based systems 925, a more adaptive process is enabled. For example, duration of access will generally be much less correlated with navigational proximity than access sequences will be, and therefore provide a better indicator of true user preferences and/or intentions and/or intentions. Therefore, combining access sequences and access duration will generally provide better inferences and associated system structural updates than using either usage behavior alone. Effectively utilizing additional usage behaviors as described above will generally enable increasingly effective system structural updating. In addition, the one or more computer-based systems 925 may employ user affinity groups to enable even more effective system structural updating than are available merely by applying either individual (personal) usage behaviors or entire community usage behaviors.

Furthermore, relying on only one or a limited set of usage behavioral cues and signals may more easily enable potential “spoofing” or “gaming” of the one or more computer-based systems 925. “Spoofing” or “gaming” the one or more computer-based systems 925 refers to conducting consciously insincere or otherwise intentional usage behaviors 920, so as to influence the costs of advertisements 910 of the one or more computer-based systems 925. Utilizing broader sets of system usage behavioral cues and signals may lessen the effects of spoofing or gaming. One or more algorithms may be employed by the one or more computer-based systems 925 to detect such contrived usage behaviors, and when detected, such behaviors may be compensated for by the preference and interest inferencing algorithms of the one or more computer-based systems 925.

In some embodiments, the one or more computer-based systems 925 may provide users 200 with a means to limit the tracking, storing, or application of their usage behaviors 920. A variety of limitation variables may be selected by the user 200. For example, a user 200 may be able to limit usage behavior tracking, storing, or application by usage behavior category described in Table 1. Alternatively, or in addition, the selected limitation may be specified to apply only to particular user communities or individual users 200. For example, a user 200 may restrict the application of the full set of her process usage behaviors 920 to preference or interest inferences by one or more computer-based systems 925 for application to only herself, and make a subset of process behaviors 920 available for application to users only within her workgroup, but allow none of her process usage behaviors to be applied by the one or more computer-based systems 925 in making inferences of preferences and/or intentions and/or intentions or interests for other users.

User Communities

As described above, a user associated with one or more systems 925 may be a member of one or more communities of interest, or affinity groups, with a potentially varying degree of affinity associated with the respective communities. These affinities may change over time as interests of the user 200 and communities evolve over time. The affinities or relationships among users and communities may be categorized into specific types. An identified user 200 may be considered a member of a special sub-community containing only one member, the member being the identified user. A user can therefore be thought of as just a specific case of the more general notion of user or user segments, communities, or affinity groups.

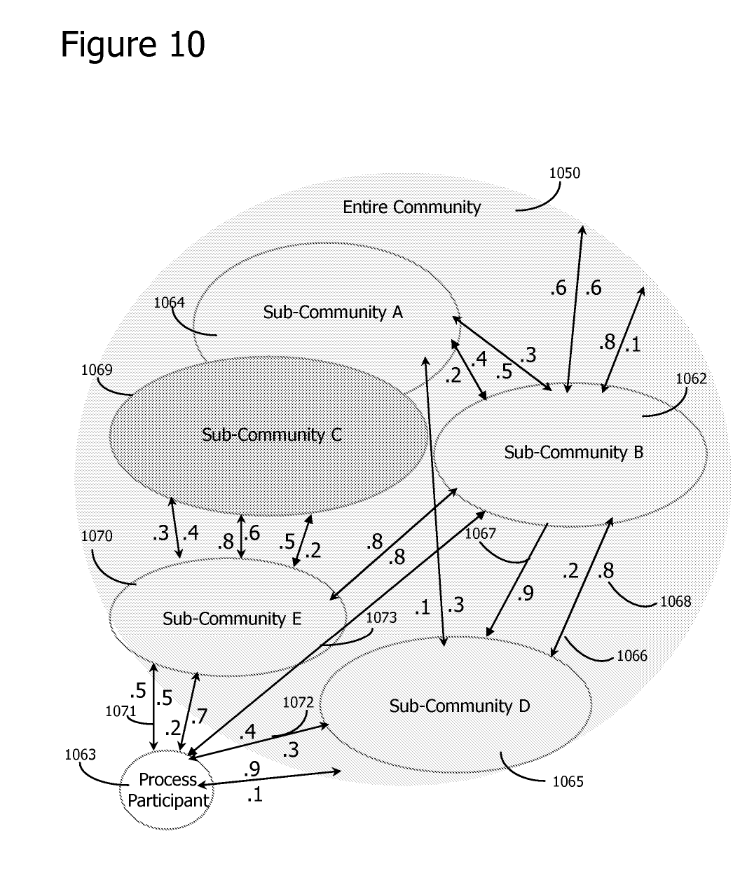

FIG. 10 illustrates the affinities among user communities and how these affinities may automatically or semi-automatically be updated by the one or more computer-based systems 925 based on user preferences and/or intentions which are derived from user behaviors 920. An entire community 1050 is depicted in FIG. 10. The community may extend across organizational, functional, or process boundaries. The entire community 1050 includes sub-community A 1064, sub-community B 1062, sub-community C 1069, sub-community D 1065, and sub-community E 1070. A user 1063 who is not part of the entire community 1050 is also featured in FIG. 10.

Sub-community B 1062 is a community that has many relationships or affinities to other communities. These relationships may be of different types and differing degrees of relevance or affinity. For example, a first relationship 1066 between sub-community B 1062 and sub-community D 1065 may be of one type, and a second relationship 1067 may be of a second type. (In FIG. 10, the first relationship 1066 is depicted using a double-pointing arrow, while the second relationship 1067 is depicted using a unidirectional arrow.)

The relationships 1066 and 1067 may be directionally distinct, and may have an indicator of relationship or affinity associated with each distinct direction of affinity or relationship. For example, the first relationship 1066 has a numerical value 1068, or relationship value, of “0.8.” The relationship value 1068 thus describes the first relationship 1066 between sub-community B 1062 and sub-community D 1065 as having a value of 0.8.

The relationship value may be scaled as in FIG. 10 (e.g., between 0 and 1), or may be scaled according to another interval. The relationship values may also be bounded or unbounded, or they may be symbolically represented (e.g., high, medium, low).

The user 1063, which could be considered a user community including a single member, may also have a number of relationships to other communities, where these relationships are of different types, directions and relevance. From the perspective of the user 1063, these relationship types may take many different forms. Some relationships may be automatically formed by the one or more computer-based systems 925, for example, based on interests or geographic location or similar traffic/usage patterns. Thus, for example the entire community 1050 may include users in a particular city. Some relationships may be context-relative. For example, a community to which the user 1063 has a relationship could be associated with a certain process, and another community could be related to another process. Thus, sub-community E 1070 may be the users associated with a product development business to which the user 1063 has a relationship 1071; sub-community B 1062 may be the members of a cross-business innovation process to which the user 1063 has a relationship 1073; sub-community D 1065 may be experts in a specific domain of product development to which the user 1063 has a relationship 1072. The generation of new communities which include the user 1063 may be based on the inferred interests of the user 1063 or other users within the entire community 1050.

Membership of communities may overlap, as indicated by sub-communities A 1064 and C 1069. The overlap may result when one community is wholly a subset of another community, such as between the entire community 1050 and sub-community B 1062. More generally, a community overlap will occur whenever two or more communities contain at least one user or user in common. Such community subsets may be formed automatically by the one or more systems 925, based on preference inferencing from user behaviors 920. For example, a subset of a community may be formed based on an inference of increased interest or demand of particular content or expertise of an associated community. The one or more computer-based systems 925 is also capable of inferring that a new community is appropriate. The one or more computer-based systems 925 will thus create the new community automatically.

For each user, whether residing within, say, sub-community A 1064, or residing outside the community 1050, such as the user 1063, the relationships (such as arrows 1066 or 1067), affinities, or “relationship values” (such as numerical indicator 1068), and directions (of arrows) are unique. Accordingly, some relationships (and specific types of relationships) between communities may be unique to each user. Other relationships, affinities, values, and directions may have more general aspects or references that are shared among many users, or among all users of the one or more computer-based systems 925. A distinct and unique mapping of relationships between users, such as is illustrated in FIG. 10, could thus be produced for each user by the one or more computer-based systems 925.

The one or more computer-based systems 925 may automatically generate communities, or affinity groups, based on user behaviors 920 and associated preference inferences. In addition, communities may be identified by users, such as administrators of the process or sub-process instance 930. Thus, the one or more computer-based systems 925 utilizes automatically generated and manually generated communities.

The communities, affinity groups, or user segments aid the one or more computer-based systems 925 in matching interests optimally, developing learning groups, prototyping process designs before adaptation, and many other uses. For example, some users that use or interact with the one or more computer-based systems 925 may receive a preview of a new adaptation of a process for testing and fine-tuning, prior to other users receiving this change.

The users or communities may be explicitly represented as elements or objects within the one or more computer-based systems 925.

Preference and/or Intention Inferences

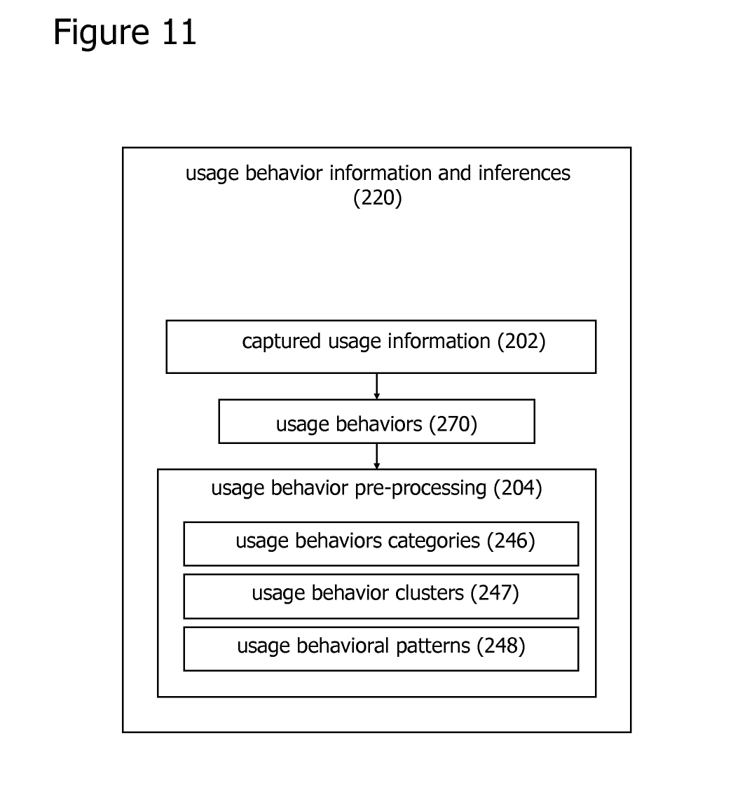

The usage behavior information and inferences function 220 of the one or more computer-based systems 925 is depicted in the block diagram of FIG. 11. Recall from FIG. 8A that the usage behavior information and inferences function 220 tracks or monitor usage behaviors 920 of users 200. The usage behavior information and inferences function 220 denotes captured usage information 202, further identified as usage behaviors 270, and usage behavior pre-processing 204. The usage behavior information and inferences function 220 thus reflects the tracking, storing, classification, categorization, and clustering of the use and associated usage behaviors 920 of the one or more users or users 200 interacting with the one or more computer-based systems 925.

The captured usage information 202, known also as system usage or system use 202, includes any interaction by the one or more users or users 200 with the system, or monitored behavior by the one or more users 200. The one or more computer-based systems 925 may track and store user key strokes and mouse clicks, for example, as well as the time period in which these interactions occurred (e.g., timestamps), as captured usage information 202. From this captured usage information 202, the one or more computer-based systems 925 identifies usage behaviors 270 of the one or more users 200 (e.g., web page access or physical location changes of the user). Finally, the usage behavior information and inferences function 220 includes usage-behavior pre-processing, in which usage behavior categories 246, usage behavior clusters 247, and usage behavioral patterns 248 are formulated for subsequent processing of the usage behaviors 270 by the one or more computer-based systems 925. Some usage behaviors 270 identified by the one or more computer-based systems 925, as well as usage behavior categories 246 designated by the one or more computer-based systems 925, are listed in Table 1, above, and are described in more detail below.

The usage behavior categories 246, usage behaviors clusters 247, and usage behavior patterns 248 may be interpreted with respect to a single user 200, or to multiple users 200, in which the multiple users may be described herein as a community, an affinity group, or a user segment. These terms are used interchangeably herein. A community is a collection of one or more users, and may include what is commonly referred to as a “community of interest.” A sub-community is also a collection of one or more users, in which members of the sub-community include a portion of the users in a previously defined community. Communities, affinity groups, and user segments are described in more detail, below.

Usage behavior categories 246 include types of usage behaviors 270, such as accesses, referrals to other users, collaboration with other users, and so on. These categories and more are included in Table 1, above. Usage behavior clusters 247 are groupings of one or more usage behaviors 270, either within a particular usage behavior category 246 or across two or more usage categories. The usage behavior pre-processing 204 may also determine new “clusterings” of user behaviors 270 in previously undefined usage behavior categories 246, across categories, or among new communities. Usage behavior patterns 248, also known as “usage behavioral patterns” or “behavioral patterns,” are also groupings of usage behaviors 270 across usage behavior categories 246. Usage behavior patterns 248 are generated from one or more filtered clusters of captured usage information 202.

The usage behavior patterns 248 may also capture and organize captured usage information 202 to retain temporal information associated with usage behaviors 270. Such temporal information may include the duration or timing of the usage behaviors 270, such as those associated with reading or writing of written or graphical material, oral communications, including listening and talking, or physical location of the user 200, potentially including environmental aspects of the physical location(s). The usage behavioral patterns 248 may include segmentations and categorizations of usage behaviors 270 corresponding to a single user of the one or more users 200 or according to multiple users 200 (e.g., communities or affinity groups). The communities or affinity groups may be previously established, or may be generated during usage behavior pre-processing 204 based on inferred usage behavior affinities or clustering. Usage behaviors 270 may also be derived from the use or explicit preferences and/or intentions 252 associated with other systems.

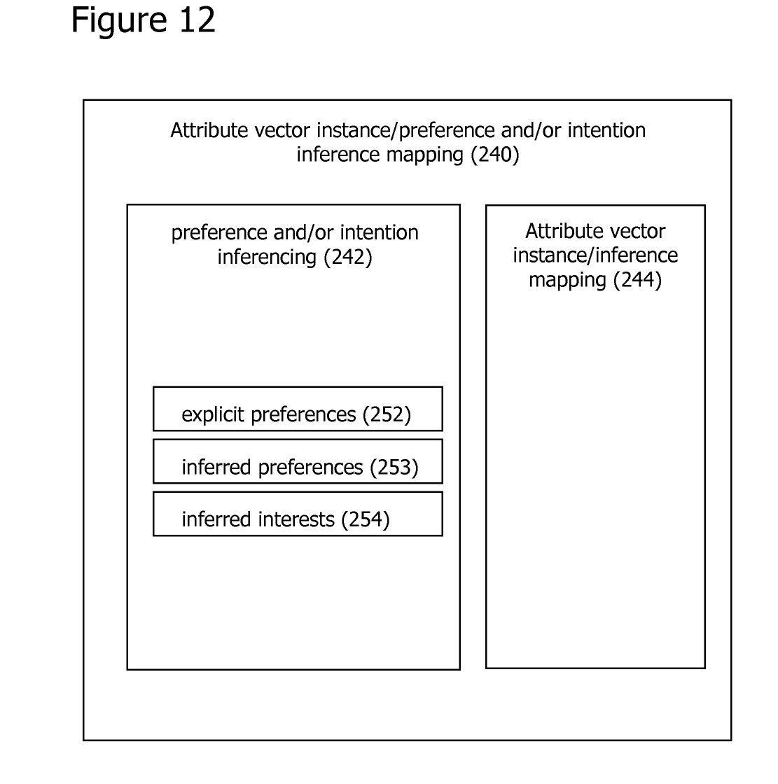

FIG. 12 is a block diagram of the attribute vector instance/behavior inference mapping function 240 used by the one or more computer-based systems 925 of FIG. 8A. The attribute vector instance/behavior inference mapping function 240 includes two algorithms, a preference inferencing algorithm 242 and an attribute vector instance/inference mapping algorithm 244.

Preferences and/or intentions describe the likes, tastes, partiality, and/or conscious or unconscious intention of the user 200 that may be inferred during access of, interaction with, or while attention is directed to, the one or more computer-based systems 925. In general, user preferences and/or intentions exist consciously or sub-consciously within the mind of the user. Since the one or more computer-based systems 925 has no direct access to these preferences and/or intentions, they are generally inferred by the preference and/or intention inferencing algorithm 242 of the attribute vector instance/behavior inference mapping function 240.

The preference inferencing algorithm 242 infers preferences and/or intentions based, at least in part, on information that may be obtained as the user 200 accesses the one or more computer-based systems 925. Additional information may also be optionally used by the preference inferencing algorithm 242, including meta-information and/or intrinsic information associated with an item of content or an object within the one or more computer-based systems 925. In addition or alternatively, preferences and/or intentions may be derived from information, rules, or algorithms accessed from other computer-based functions residing within the one or more computer-based systems 925, or through access to, or interaction with, other computer-based functions residing outside of the one or more computer-based systems 925.

The preference and/or intention inferencing algorithm and associated output 242 is also described herein generally as “preference inferencing” or “preference inferences” of the one or more computer-based systems 925. The preference inferencing algorithm 242 identifies three types of preferences and/or intentions: explicit preferences and/or intentions 252, inferred preferences and/or intentions 253, and inferred interests 254. Unless otherwise stated, the use of the term “preferences and/or intentions” herein is meant to include any or all of the elements 252, 253, and 254 depicted in FIG. 12.

As used herein, explicit preferences and/or intentions 252 describe explicit choices or designations made by the user 200 during use of the one or more computer-based systems 925. The explicit preferences and/or intentions 252 may be considered to more explicitly reveal preferences and/or intentions than inferences associated with other types of usage behaviors. A response to a survey is one example where explicit preferences and/or intentions 252 may be identified by the one or more computer-based systems 925.

Inferred preferences and/or intentions 253 describe preferences and/or intentions of the user 200 that are based on usage behavioral patterns 248. Inferred preferences and/or intentions 253 are derived from signals and cues made by the user 200, where “signals” are consciously intended communications by the user, and “cues” are behaviors that are not intended as explicit communications by the user, but nevertheless provide information about a user with which to infer preferences and/or intentions and interests.

Inferred interests 254 describe interests of the user 200 that are based on usage behavioral patterns 248. In general, inferences generated by the attribute vector instance/behavior inference mapping function 240 are derived from the preference inferencing algorithm 242 and combine inferences from overall user community behaviors and preferences and/or intentions, inferences from sub-community or expert behaviors and preferences and/or intentions, and inferences from personal user behaviors and preferences and/or intentions. As used herein, preferences (whether explicit 252 or inferred 253) are distinguishable from interests (254) in that preferences and/or intentions imply a ranking (e.g., object A is better than object B) while interests do not necessarily imply a ranking.

The preference and/or intention inferencing algorithm 242 may be augmented by automated inferences and interpretations about the content within individual and sets of items of content or objects within the one or more computer-based systems 925 using statistical pattern matching of words, phrases or representations, in written or audio format, or in pictorial format, within the content. Such statistical pattern matching may include, but is not limited to, application of principle component analysis, semantic network techniques, Bayesian analytical techniques, neural network-based techniques, support vector machine-based techniques, or other statistical analytical techniques.

A second algorithm 244, designated “attribute vector instance/inference mapping” 244, matches attribute vector instances 2020a with preference and/or intention inferences 242. The matching procedure may apply statistical models to determine the best fit of the inferences 242 and attribute vector instances 2020a.

According to some embodiments, FIG. 13 is a summary schematic of advertising recipient behavior-based advertising process 3002. The one or more computer-based systems 925b deliver advertisements 910b to the one or more users 200. It should be understood that advertising may be delivered 265b to advertising recipients 260 that are not current and/or historic users 200 of the one or more computer-based systems 925b. The one or more computer-based systems 925b include the advertising recipient behavior processing 3001 of FIG. 7.

Upon receipt of the advertisements 910b by users 200, selective usage behaviors 920b associated with the one or more users 200 are accessible and monitored by the advertising recipient behavior processing function 3001 of the one or more computer based systems 925b. The one or more monitored usage behaviors may include, but are not limited to, the behavior categories and aasociated behaviors referenced in Table 1. The behaviors that apply may be within a specific user session, and may be in conjunction with an anonymous user, or may be in conjunction with a user that is known through an authentication process, and may have an explicit profile. Advertising recipient behaviors 920b may also be tracked across individual computer sessions, where the user can be appropriately identified, and fees calculated based on behaviors 925b across sessions. In these cases, some time limit will typically apply. For example, if a user 200 clicked on an advertisement in one session, and then a few days later, the same user purchased a product at the destination site of the advertisement, in some embodiments this could result in a fee associated to the advertiser related to the purchase in addition to, or instead of, a fee associated with the click on the advertisement. This multi-session or persistent user behavior tracking method may apply to any advertising recipient behaviors 920b, and constraints or limits such as time limits may be applied as appropriate. Further the behaviors of other users 200 that may be influenced by a first user 200 that is an advertising recipient and executes behavior 920b that influences the behaviors 920b of the others (e.g., a referral behavior) may be tracked across sessions and systems, and fees may accrue to the first 200 user depending on the behaviors 920b of the potentially influenced users 200. This tracking of influence behaviors my continue across the sequentially influencing behaviors 920b of a plurality of users 200 without limit.

The one or more monitored usage behaviors are then mapped 3050 to an advertising recipient behavior vector 3122 and associated fee instance 3124. If the mapping results in at least one fee, an advertising fee is calculated 3060. The advertising fee calculation may apply logic or rules defined in the establish price of advertising of one or more advertising recipient vector fee instances and rules 3030 step of the advertisement recipient behavior-based pricing process 3000. An algorithm may be applied in the “calculate advertising fee” step 3060 of process 3001 to resolve cases in which multiple behaviors correspond to multiple fees. In some cases, fees associated with certain behaviors will be additive, in other cases some fees associated with corresponding behaviors will supersede other fees, and in other cases, some other function than supercession or strict addition may be applied to resolve multiple behavioral fees to calculate a total fee to the advertiser.

The advertiser is then billed 3070 for one or more of the total fees associated with one or more ad recipients. The fees may be aggregated over some period of time (e.g., monthly).

According to some embodiments, FIG. 14 is a summary schematic of multi-attribute and advertising recipient-based advertising process 2002b, which is a combination of advertising recipient behavior-based advertising process 3002 and a multi-attribute advertising delivery process 2002.

One or more users 200 interact 915 with one or more computer-based systems 925. The interactions 915 may be in conjunction with navigating the systems, performing a search, or any other usage behavior, including, but not limited to, those referenced by the usage behavior categories referenced by Table 1. Selective usage behaviors 920 associated with the one or more users 200 are accessible by the one or more computer based systems 925. The one or more computer-based systems 925 includes the multi-attribute advertising delivery process 2001 of FIG. 6A, which in turn includes a function to manage usage behavior information and inferences on user preferences and/or intentions 220, a function that manages attribute vector instances 2020a, and a function that maps one or more attribute vector instances with one of more user preference and/or intention inferences 240.

The one or more computer-based systems 925 deliver advertisements 910 to the one or more users 200 based on the mapping of attribute vector instances and usage behavior information and/or inferences 240. It should be understood that advertising may be delivered 265 to advertising recipients 260 that are not current and/or historic users 200 of the one or more computer-based systems 925.

Upon receipt of the advertisements 910 by users 200, selective usage behaviors 920b associated with the one or more users 200 are accessible and monitored by the advertising recipient behavior processing function 3001 of the one or more computer based systems 925b. The one or more monitored usage behaviors may include, but are not limited to, the categories of behaviors and associated behaviors referenced in Table 1. The behaviors may be within a specific user session, and may be in conjunction with an anonymous user, or may be in conjunction with a user that is known through an authentication process, and may have an explicit profile. Advertising recipient behaviors 920b may also be tracked across individual computer sessions, where the user can be appropriately identified and fees calculated based on behaviors across sessions. Some time limit will typically apply. For example, if a user 200 clicked on an advertisement in one session, and then a few days later, the same user purchased a product at the destination site of the advertisement, in some embodiments this could result in a fee associated to the advertiser related to the purchase in addition to, or instead of, a fee associated with the click on the advertisement. This multi-session or persistent user behavior tracking method may apply to any advertising recipient behaviors 920b, and may be constraints or limits such as time limits may be applied as appropriate. Further the behaviors of other users 200 that may be influenced by a first user 200 that is an advertising recipient and executes behavior 920b that influences the behaviors 920b of the others (e.g., a referral behavior) may be tracked across sessions and systems, and fees may accrue to the first 200 user depending on the behaviors 920b of the potentially influenced users 200.

If the mapping results in at least one fee, an advertising fee is calculated 3060. The advertising fee calculation may apply logic or rules defined in the establish price of advertising of one or more advertising recipient vector fee instances and rules 3030 step of the advertisement recipient behavior-based pricing process 3000. An algorithm may be applied in “the calculate advertising fee” 3060 step of process 3001 to resolve cases in which multiple behaviors correspond to multiple fees. In some cases, fees associated with certain behaviors will be additive, in other cases some fees associated with corresponding behaviors will supersede other fees, and in other cases, some other function than supercession or strict addition may be applied to resolve multiple behavioral fees to calculate a total fee to the advertiser.

The advertiser is then billed 3070 for one or more of the total fees associated with one or more ad recipients. The fees may be aggregated over some period of time (e.g., monthly).

Although not explicitly shown on FIG. 14, it should be understood that multi-attribute and advertising recipient-based advertising process 2002b of FIG. 14 may include the transparent ad delivery rationale multi-attribute advertising process 2001i of FIGS. 6B and 8B. In such embodiments, ad recipients 200,260 may have access to, and/or have the ability to interact with, the logic or rationale for the delivery of the advertisement 910,265 to the ad recipient as described previously herein.

Computing Infrastructure

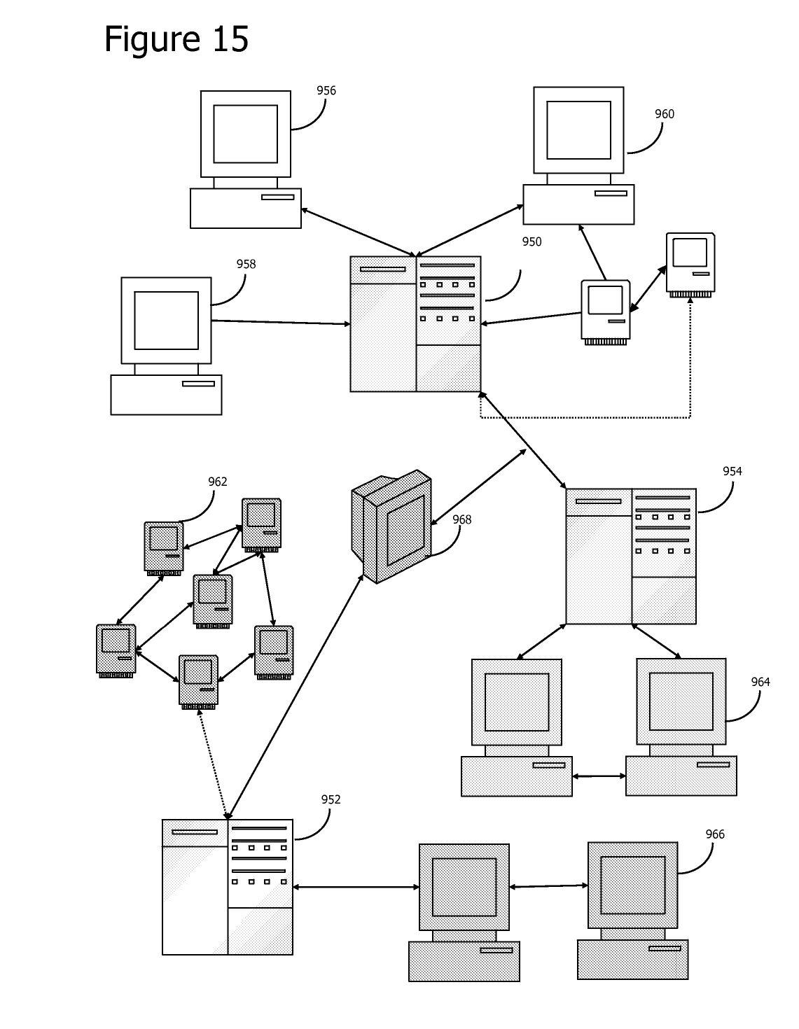

FIG. 15 depicts various computer hardware and network topologies that the multi-attribute and behavior-based advertising pricing process and system 10, multi-attribute advertising pricing process 2000, multi-attribute advertising process 2002, the multi-attribute advertising delivery process and system 2001, the advertising delivery rationale processes and systems 2001i and 2002i, the advertising recipient behavior-based pricing process and system 3000, the advertising recipient behavior-based processing function 3001, the advertising recipient behavior-based advertising process and system 3002, and the multi-attribute and advertising recipient behavior-based advertising process and system 2002b may embody, collectively defined as “the relevant systems” heretoafter.

Servers 950, 952, and 954 are shown, perhaps residing at different physical locations, and potentially belonging to different organizations or individuals. A standard PC workstation 956 is connected to the server in a contemporary fashion, potentially through the Internet. It should be understood that the workstation 956 can represent any computer-based device, mobile or fixed, including a set-top box. In this instance, the relevant systems, in part or as a whole, may reside on the server 950, but may be accessed by the workstation 956. A terminal or display-only device 958 and a workstation setup 960 are also shown. The PC workstation 956 or servers 950 may be connected to a portable processing device (not shown), such as a mobile telephony device, which may be a mobile phone or a personal digital assistant (PDA). The mobile telephony device or PDA may, in turn, be connected to another wireless device such as a telephone or a GPS receiver.

FIG. 15 also features a network of wireless or other portable devices 962. The relevant systems may reside, in part or as a whole, on all of the devices 962, periodically or continuously communicating with the central server 952, as required. A workstation 964 connected in a peer-to-peer fashion with a plurality of other computers is also shown. In this computing topology, the relevant systems, as a whole or in part, may reside on each of the peer computers 964.

Computing system 966 represents a PC or other computing system, which connects through a gateway or other host in order to access the server 952 on which the relevant systems, in part or as a whole, reside. An appliance 968, includes software “hardwired” into a physical device, or may utilize software running on another system that does not itself host the relevant systems. The appliance 968 is able to access a computing system that hosts an instance of one of the relevant systems, such as the server 952, and is able to interact with the instance of the system.

While the present invention has been described with respect to a limited number of embodiments, those skilled in the art will appreciate numerous modifications and variations therefrom. It is intended that the appended claims cover all such modifications and variations as fall within the scope of this present invention.

What is claimed is:

1. A multi-behavior advertising method comprising:
establishing an advertising recipient behavior vector comprising a plurality of behavior types;
associating a fee function to a subset of the plurality of behavior types of the advertising recipient behavior vector;
associating a plurality of behaviors of an advertising recipient to an advertising recipient behavior vector subset and the corresponding fee function; and
determining an advertising fee associated with the plurality of behaviors of the advertising recipient.

2. The method of claim 1 wherein establishing an advertising recipient behavior vector comprising a plurality of behavior types comprises:
establishing a behavior type, the behavior type being selected from a group consisting of a purchase, a visit to the advertiser's physical location, a referencing of the advertisement for future access, the referral of the advertisement to one or more other people, a click on the advertisement, the interaction with an on-line explanation on why the advertisement was delivered to the advertisement recipient, and the duration of visiting the destination site of the advertisement.

3. The method of claim 1, wherein associating a fee function to a subset of the plurality of behavior types of the advertising recipient behavior vector comprises:
applying a behavioral limit that constitutes a basis for advertising fee calculations.

4. The method of claim 3, wherein applying a behavioral limit that constitutes a basis for advertising fee calculations comprises:
applying a computer system session-based limit.

5. The method of claim 3, wherein applying a behavioral limit that constitutes a basis for advertising fee calculations comprises:
applying a temporal-based limit.

6. The method of claim 1, wherein associating a fee function to a subset of the plurality of behaviors of the advertising recipient behavior vector comprises:
establishing a fee that is a fixed amount for the corresponding subset of the plurality of behavior types.

7. The method of claim 1, wherein associating a fee function to a subset of the plurality of behaviors of the advertising recipient behavior vector comprises:
establishing a fee that is a variable function of the corresponding subset of the plurality of behavior types.

8. The method of claim 1, wherein associating a fee function to a subset of the plurality of behavior types of the advertising recipient behavior vector comprises:
establishing a fee function based on a bidding process.

9. The method of claim 1, wherein determining an advertising fee associated with the one or more behaviors of the advertising recipient comprises:
applying a procedure to generate a total advertising fee by reconciling a plurality of advertising fees corresponding to a plurality of advertising recipient behaviors.

10. The method of claim 1, wherein determining an advertising fee associated with the one or more behaviors of the advertising recipient comprises:
tracking the one or more behaviors across a plurality of computer sessions to determine an advertising fee.

11. A multi-behavior advertising system comprising:
an advertising recipient behavior vector comprising a plurality of behavior types;
a fee function corresponding to a subset of the plurality of behaviors of the advertising recipient behavior vector;
a mapping of a plurality of behaviors of an advertising recipient to the advertising recipient behavior vector subset and corresponding fee function; and
means to determine an advertising fee associated with the one or more behaviors of the advertising recipient.

12. The system of claim 11 wherein an advertising recipient behavior vector comprising a plurality of behaviors comprises:
an advertising recipient behavior, wherein the behavior is selected from a group consisting of a purchase, a visit to the advertiser's physical location, a referencing of the advertisement for future access, the referral of the advertisement to one or more other people, a click on the advertisement, the interaction with an on-line explanation on why the advertisement was delivered to the advertisement recipient, and the duration of visiting the destination site of the advertisement.

13. A behavior-based advertising system comprising:
an advertising recipient behavior, wherein the behavior is selected from a group consisting of a visit to the advertiser's physical location, a referencing of the advertisement for future access, the referral of the advertisement to one or more other people, the interaction with an on-line explanation of why the advertisement was delivered to the advertisement recipient, and the duration of visiting the destination site of the advertisement;
a fee function corresponding to the advertising recipient behavior;
means to monitor one or more behaviors of an advertising recipient upon receipt of an advertisement; and
means to determine an advertising fee associated with the behavior of an advertising recipient.

14. A multi-attribute advertising pricing system comprising:
an advertising recipient attribute vector comprising a plurality of advertising recipient attributes;
one or more attribute instances corresponding to an advertising recipient attribute vector;
an advertising fee function associated with an attribute instance;
means of delivering advertising based on inferring a plurality of values of an attribute instance corresponding to a potential advertising recipient; and
means of determining an advertising fee associated with the delivered advertising.

15. The system of claim 14 wherein an advertising recipient attribute vector comprising a plurality of advertising recipient attributes comprises:
an attribute selected from a group consisting of a physical location, a physiological response, and an environmental condition.

16. The system of claim 14 further comprising:
means to automatically determine a physical location of a potential advertising recipient.

17. A multi-attribute advertising system comprising:
an advertising recipient attribute vector comprising a plurality of advertising recipient attributes; and
means to deliver a variation of an advertisement to an advertising recipient based on a plurality of advertisement attributes associated with the advertisement recipient.

18. A multi-attribute advertising system comprising:
an advertising recipient attribute vector comprising a plurality of advertising recipient attributes;
means to deliver an advertisement to an advertising recipient based on a plurality of advertisement attributes associated with the advertisement recipient; and
means to deliver an explanation to the advertising recipients why the advertisement was delivered to the advertising recipient.

19. The system of claim 18 wherein means to deliver an explanation to the advertising recipients why the advertisement was delivered to the advertising recipient comprises:
means to interactively deliver an explanation to the advertising recipients why the advertisement was delivered to the advertising recipient.
